(19) United States
(12) Patent Application Publication
(10) Pub. No.: US 2024/0314869 A1
(43) Pub. Date: Sep. 19, 2024

(54) JOINT TRANSMISSION OPERATION IN WI-FI-NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/601,900

(22) Filed: Mar. 11, 2024

Related U.S. Application Data
(60) Provisional application No. 63/452,304, filed on Mar. 15, 2023.
(60) Provisional application No. 63/524,177, filed on Jun. 29, 2023.
(60) Provisional application No. 63/524,181, filed on Jun. 29, 2023.

(51) Int. Cl. H04W 76/15; H04L 25/02; H04W 8/22; H04W 72/0453

(52) U.S. Cl. CPC H04W 76/15; H04L 25/0224; H04W 8/22; H04W 72/0453

(57) ABSTRACT

Methods and apparatuses for joint transmission operations in Wi-Fi networks. A method of wireless communication performed by a first access point (AP) includes determining that the first AP and other APs of a plurality of APs want to perform joint transmission (JTX) with stations (STAs) associated with the first AP and the other APs. The method also includes initiating a JTX procedure including forming a logical AP multi-link device (MLD) or a virtual AP MLD with the other APs to perform JTX.

### CROSS-REFERENCE TO RELATED APPLICATION(S) AND CLAIM OF PRIORITY

This application claims priority under 35 U.S.C. § 119(e) to U.S. Provisional Patent Application No. 63/452,304 filed on Mar. 15, 2023, U.S. Provisional Patent Application No. 63/524,177 filed on Jun. 29, 2023, and U.S. Provisional Patent Application No. 63/524,181 filed on Jun. 29, 2023, which are hereby incorporated by reference in their entirety.

### TECHNICAL FIELD

This disclosure relates generally to wireless communications systems, and more particularly to joint transmission operations in Wi-Fi networks.

### BACKGROUND

Wireless local area network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Indoor positioning has grown in popularity over the last decade in parallel with the growth in the number of personal wireless devices as well as wireless infrastructure. While the use cases are plentiful and include smart homes and buildings, surveillance, disaster management, industry and healthcare, they all require wide availability and good accuracy. A key step of most positioning/localization solutions is ranging which involves identification of the distance (or a difference in distances) of the target device from a set of anchor devices whose locations are known. Correspondingly several ranging techniques have been proposed in Ultra-wide band (UWB), Lidar and WiFi. In fact, WiFi standards groups like 802.11mc and 802.11az have been specifically tailored for enabling accurate WiFi-based ranging via the Fine Timing Measurement (FTM) protocol. Several such FTM methods have been proposed: EDCA-based ranging, Trigger-based (TB) ranging, non-TB ranging, Passive TB ranging, etc.

### SUMMARY

Embodiments of the present disclosure provide methods and apparatuses for joint transmission operations in Wi-Fi networks.

In one embodiment, a method of wireless communication performed by a first access point (AP) includes determining that the first AP and other APs of a plurality of APs want to perform joint transmission (JTX) with stations (STAs) associated with the first AP and the other APs. The method also includes initiating a JTX procedure including forming a logical AP multi-link device (MLD) or a virtual AP MLD with the other APs to perform JTX.

In another embodiment, a first access point (AP) device includes a transceiver configured to communicate over a link with a corresponding station (STA). A processor is operably coupled to the transceiver, the processor configured to: determine that the first AP and other APs of a plurality of APs want to perform joint transmission (JTX) with stations (STAs) associated with the first AP and the other APs; and initiate a JTX procedure including forming a logical AP multi-link device (MLD) or a virtual AP MLD with the other APs to perform JTX.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example of single AP transmission according to various embodiments of the present disclosure;

FIG. 4 illustrates an example of a joint transmission scheme according to various embodiments of the present disclosure;

FIG. 5 illustrates an example of a STA being served via multiple APs simultaneously according to various embodiments of the present disclosure;

FIG. 6 illustrates an example for channel access according to various embodiments of the present disclosure;

FIG. 7 illustrates another example for channel access according to various embodiments of the present disclosure;

FIG. 8 illustrates yet another example for channel access according to various embodiments of the present disclosure;

FIG. 9 illustrates an example of a joint transmission scheme based on a logical AP MLD setup according to various embodiments of the present disclosure;

FIG. 10 illustrates an example of a method for logical AP MLD formation for joint transmission according to various embodiments of the present disclosure;

FIG. 11 illustrates an example of an architectural setup for a logical AP MLD for joint transmission according to various embodiments of the present disclosure;

FIG. 12 illustrates an example of a division of shared and non-shared component groups for the purpose of joint transmission according to various embodiments of the present disclosure;

FIG. 13 illustrates a virtual AP setup example for joint transmission according to various embodiments of the present disclosure;

FIG. 14 illustrates an example of a method for setting operation parameters for a JTX logical AP MLD according to various embodiments of the present disclosure;

FIG. 15 illustrates an example of a method for group formation for a JTX logical AP MLD according to various embodiments of the present disclosure;

FIG. 16 illustrates an example of a method for an AP to join the logical APO MLD for JTX according to various embodiments of the present disclosure;

FIG. 17 illustrates an example of a method for APs that participate in JTX via logical AP MLD to advertise a MAC address used for communication according to various embodiments of the present disclosure;

FIG. 18 illustrates an example of a method for transmission of management frames by a set of APs affiliated with a logical AP MLD according to various embodiments of the present disclosure;

FIG. 19 illustrates an example of a method for a channel sounding initiation procedure according to various embodiments of the present disclosure;

FIG. 20 illustrates an example of a method for a channel sounding procedure according to various embodiments of the present disclosure;

FIG. 21 illustrates an example of a method for a channel sounding feedback collection procedure according to various embodiments of the present disclosure;

FIG. 22 illustrates an example of a method for a channel sounding feedback processing procedure according to various embodiments of the present disclosure;

FIG. 23 illustrates an example of a method for a data sharing procedure for JTX according to various embodiments of the present disclosure;

FIG. 24 illustrates an example format of an element according to various embodiments of the present disclosure;

FIG. 25 illustrates an example format of a JTX control field format according to various embodiments of the present disclosure;

FIG. 26 illustrates an example format of an element that the STA can transmit to other APS according to various embodiments of the present disclosure;

FIG. 27 illustrates an example format of a JTX control frame according to various embodiments of the present disclosure;

FIG. 28 illustrates an example operation using the element according to various embodiments of the present disclosure;

FIG. 29 illustrates an example operation 2900 using the action frame according to various embodiments of the present disclosure;

FIG. 30 illustrates an example JTX resource information container (RIC) frame format according to various embodiments of the present disclosure;

FIG. 31 illustrates an example operation using the RIC according to various embodiments of the present disclosure;

FIG. 32 illustrates an example operation using the request and response frame according to various embodiments of the present disclosure;

FIG. 33 illustrates an example backoff hold time procedure 3300 according to various embodiments of the present disclosure;

FIG. 34 illustrates an example TWT SP alignment operation according to various embodiments of the present disclosure;

FIG. 35 illustrates an example start time boundary operation according to various embodiments of the present disclosure;

FIG. 36 illustrates another example start time boundary operation according to various embodiments of the present disclosure;

FIG. 37 illustrates an example quiet element based start time boundary operation according to various embodiments of the present disclosure;

FIG. 38 illustrates an example of a dedicated SP for JTX operation according to various embodiments of the present disclosure;

FIG. 39 illustrates an example depicting a triggered JTX operation according to various embodiments of the present disclosure;

FIG. 40 illustrates another example depicting a triggered JTX operation according to various embodiments of the present disclosure;

FIG. 41 illustrates an example operation to shorten the transmission time of uplink transmission according to various embodiments of the present disclosure;

FIG. 42 illustrates an example early termination operation to stop uplink transmission according to various embodiments of the present disclosure;

FIG. 43 illustrates an example early termination operation to stop downlink transmission according to various embodiments of the present disclosure;

FIG. 44 illustrates another example early termination operation to stop downlink transmission according to various embodiments of the present disclosure; and

FIG. 45 illustrates a flow diagram of an example of a method for wireless communication performed by a station device according to embodiments of the present disclosure.

### DETAILED DESCRIPTION

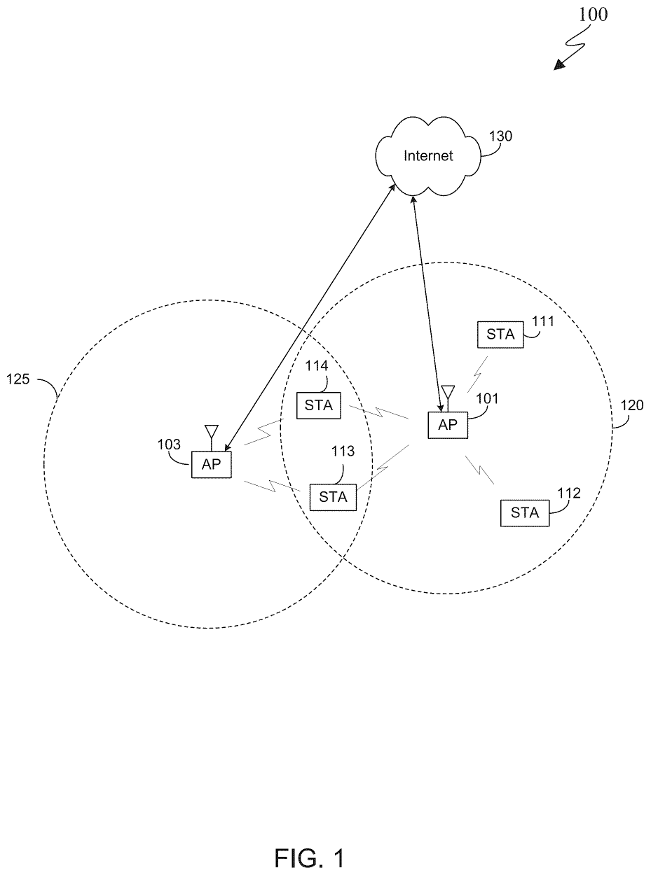

FIGS. 1 through 45, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE std. 802.11-2020, “Wireless LAN Medium Access Control (MAC) and Physical Layer (PHY) Specification”; [2] IEEE P802.11az/D5.0.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating joint transmission operations in Wi-Fi networks. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

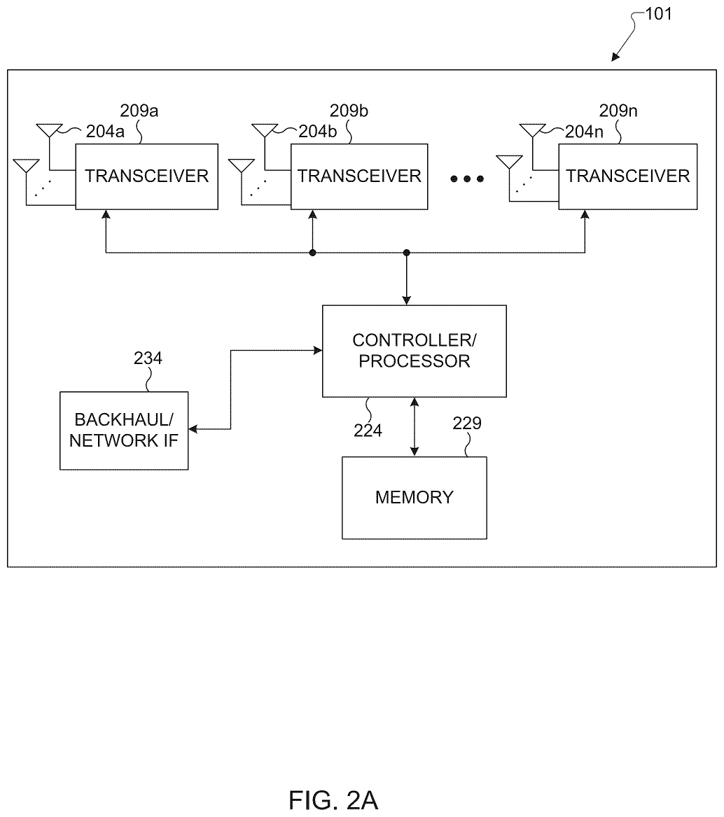

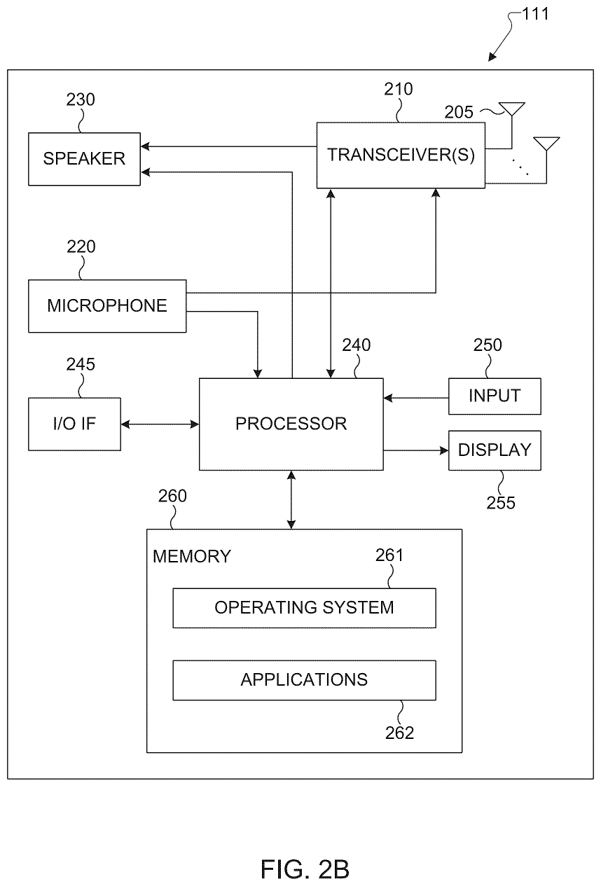

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating joint transmission operations in Wi-Fi networks. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating joint transmission operations in Wi-Fi networks. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate joint transmission operations in Wi-Fi networks. In some embodiments, the processor 240 includes at least one microprocessor or microcontroller.

The processor 240 is also capable of executing other processes and programs resident in the memory 260, such as operations for facilitating joint transmission operations in Wi-Fi networks. The processor 240 can move data into or out of the memory 260 as required by an executing process. In some embodiments, the processor 240 is configured to execute a plurality of applications 262, such as applications for facilitating joint transmission operations in Wi-Fi networks. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Various embodiments of the present disclosure recognize that rising demands for indoor Wi-Fi connectivity have led to an increase in number of co-deployed APs in indoor areas. Such multi-AP networks typically employ a limited form of coordination for various network functionalities including but not limited to spectrum sharing, interference management, etc. In order to increase the efficiency of such networks, a number of multi-AP coordination schemes are available. One of the methods is to enable a joint transmission in which multiple APs pool their antennas together to achieve the effect of one large AP performing multi-user, multiple-input, multiple-output (MU-MIMO) transmission on the downlink.

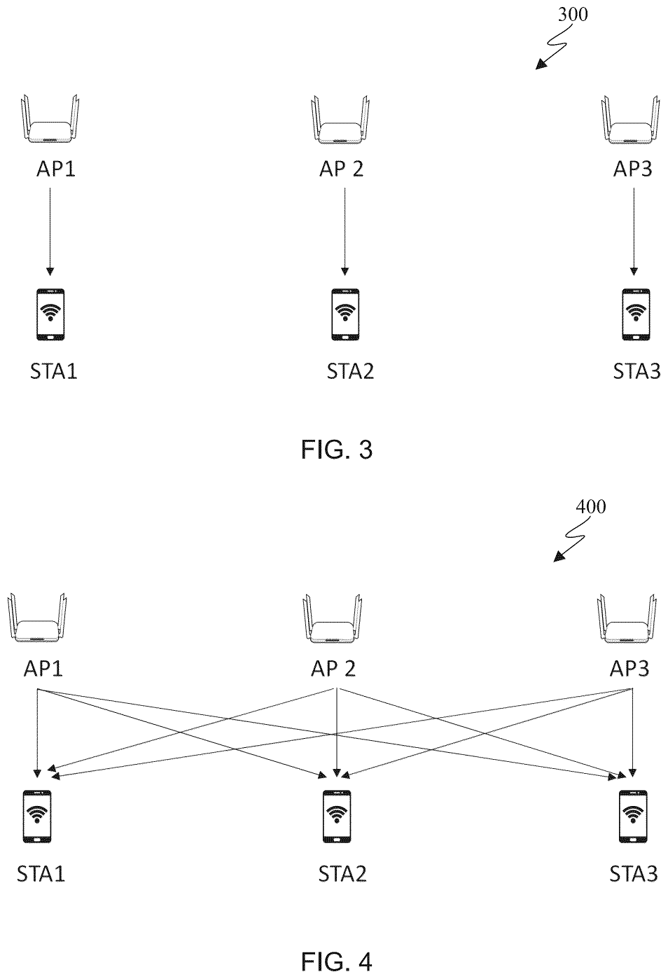

To illustrate the difference between single AP transmission and joint transmission, consider the depiction in FIG. 3 and FIG. 4.

FIG. 3 illustrates an example of single AP transmission 300 according to various embodiments of the present disclosure. The embodiment of the example of single AP transmission 300 shown in FIG. 3 is for illustration only. Other embodiments of the example of single AP transmission 300 could be used without departing from the scope of this disclosure.

As shown in FIG. 3, three APs—AP1, AP2 and AP3 are deployed in a region and share the same frequency resources (e.g., band, channel and bandwidth). STA1, STA2 and STA3 are associated with AP1, AP2 and AP3 respectively. As all the APs share the same frequency resources, they can transmit to their respective STAs one at a time.

FIG. 4 illustrates an example of a joint transmission scheme 400 according to various embodiments of the present disclosure. The embodiment of the example of joint AP transmission 400 shown in FIG. 4 is for illustration only. Other embodiments of the example of joint AP transmission 400 could be used without departing from the scope of this disclosure.

In the joint transmission example shown in FIGS. 4, AP1, AP2 and AP3 pool their antennas together thereby behaving as a large AP with higher number of antennas. These three APs behaving as one large AP perform downlink MU-MIMO transmission to STA1, STA2 and STA3. In single AP transmission, the medium would be time shared. However, in the case of joint transmission as the APs transmit the data simultaneously, there is a three-fold increase in network throughput.

Various embodiments of the present disclosure recognize that joint transmission promises a significant gain in network throughput. However, for realizing the gains, a significant amount of coordination is needed amongst the APs. For instance, the APs need to coordinate with each for performing sounding, collection of sounding feedback and also data sharing. An architecture that can enable such coordination efficiently is needed. In addition, various embodiments of the present disclosure recognize that when a STA is served via joint transmission (JTX) it can be served via multiple APs simultaneously.

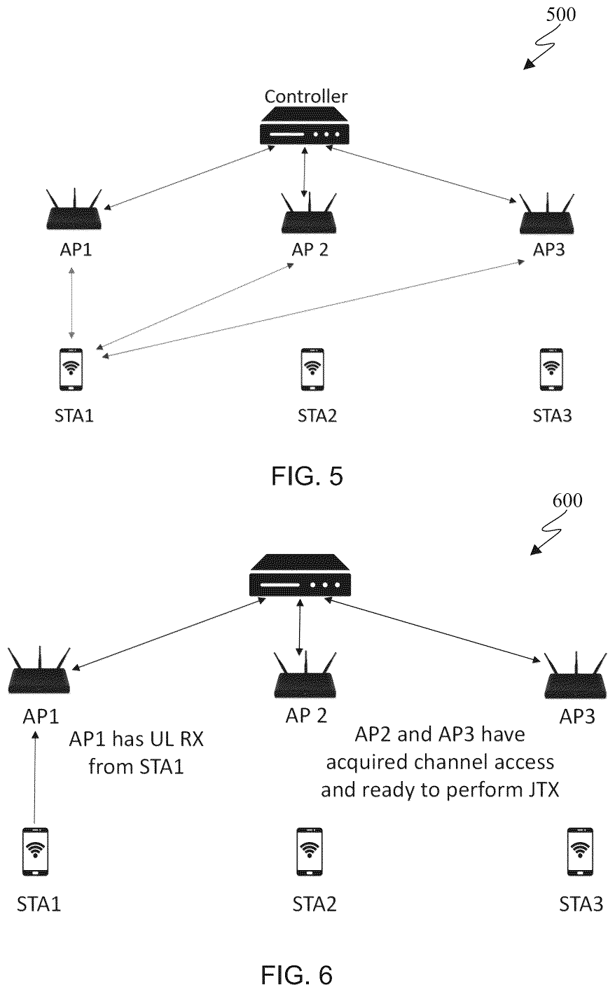

FIG. 5 illustrates an example of a STA being served via multiple APs simultaneously 500 according to various embodiments of the present disclosure. The embodiment of the STA being served via multiple APs simultaneously 500 shown in FIG. 5 is for illustration only. Other embodiments of the STA being served via multiple APs simultaneously 500 could be used without departing from the scope of this disclosure.

As shown in FIG. 5, STA1 is associated with AP1. During JTX, STA1 can receive frames from AP2 and AP3 as well. Currently, STA1 can associate with one AP only. However, without an association with AP2 and AP3, STA1 may not know how to handle frames coming from these APs. Further, DS also needs to know the mapping so that it can route the packets of STA1 to AP2 and AP3 as well. This mapping is created based on association in the standard.

Various embodiments of the present disclosure recognize that in order to perform joint transmission, all the involved APs need to be able to access the channel at the same time. Channel access for joint transmission based on conventional channel access mechanisms can lead to inefficient operation. A few examples are provided below.

Suppose that AP1, AP2 and AP3 are three APs that are involved in joint transmission. Suppose that the channel access follows the contention based channel access procedure. Thus, each of the APs can choose backoff timers and countdown to gain channel access. Since the backoff counter values are chosen by each device individually and are randomly chosen, the probability that each AP starts to contend at the exact time and also chooses the same backoff counter is low. Thus, it is possible that the backoff counter of one or more APs may not have counted down to zero when one or more of the other APs that are involved in JTX count down to zero.

FIG. 6 illustrates an example for channel access 600 where AP2 and AP3 count down to zero at the same time while AP1 counts down to zero at a different time from AP2 and AP3 according to various embodiments of the present disclosure. The embodiment of channel access where AP2 and AP3 count down to zero at the same time while AP1 counts down to zero at a different time from AP2 and AP3 shown in FIG. 6 is for illustration only. Other embodiments of channel access where AP2 and AP3 count down to zero at the same time while AP1 counts down to zero at a different time from AP2 and AP3 could be used without departing from the scope of this disclosure.

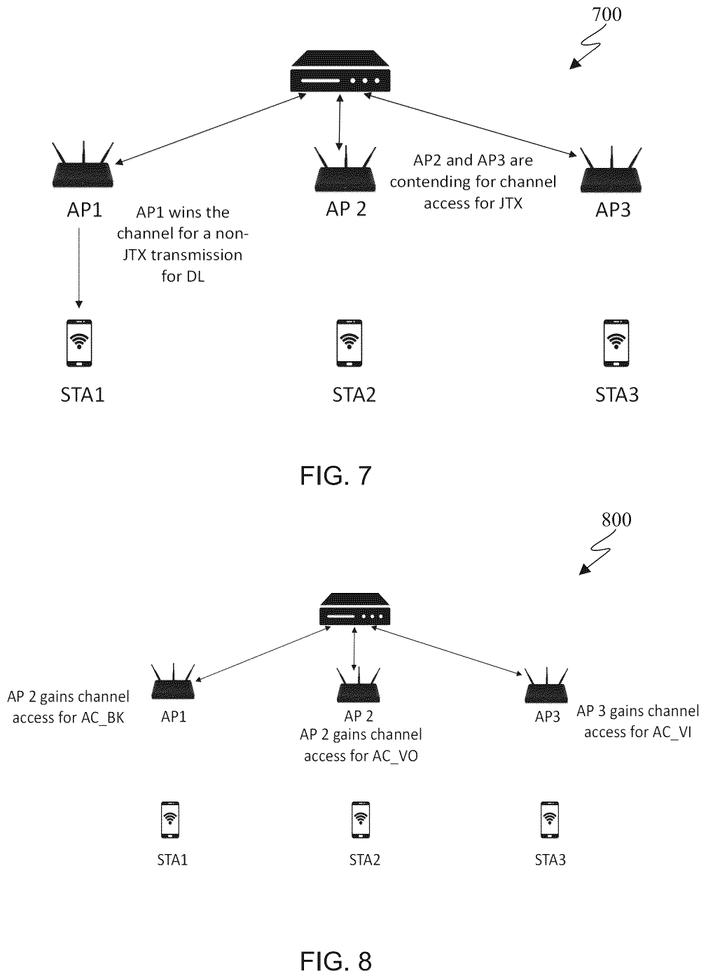

FIG. 7 illustrates another example for channel access 700 where AP1 has an ongoing downlink transmission to STA1 that is not being served by JTX according to various embodiments of the present disclosure. The embodiment of channel access where AP1 has an ongoing downlink transmission to STA1 that is not being served by JTX shown in FIG. 7 is for illustration only. Other embodiments of channel access where AP1 has an ongoing downlink transmission to STA1 that is not being served by JTX could be used without departing from the scope of this disclosure.

FIG. 8 illustrates yet another example for channel access 800 where each AP can win channel access at the same time, but win it for different access categories according to various embodiments of the present disclosure. The embodiment of channel access where each AP can win channel access at the same time, but win it for different access categories shown in FIG. 8 is for illustration only. Other embodiments of channel access where each AP can win channel access at the same time, but win it for different access categories could be used without departing from the scope of this disclosure.

As shown in the example in FIGS. 6, AP2 and AP3 count down to zero at the same time. Unfortunately, AP1 may not be available due to a number of reasons. For instance, it may not be ready as it is deferring to an ongoing uplink transmission from STA1. Thus, the joint transmission cannot start. It is also possible that not all STAs may be served via JTX. Thus, AP1 may have an ongoing downlink transmission to STA1 that is not being served via JTX as shown in FIG. 7. A similar problem can also arise in trigger based access. In another example, it is possible that each AP can win the channel at the same time but win it for a different access category (AC) as shown in FIG. 8.

Accordingly, various embodiments of the present disclosure provide mechanisms to facilitate channel access for JTX in Wi-Fi networks. Various embodiments of the present disclosure provide an architecture for enabling joint transmission, and provide various procedures for enabling joint transmission in this architecture.

In addition, various embodiments of the present disclosure provide solutions for handling a setup procedure for JTX, including: an explicit association based procedure and corresponding signaling; an AP assisted setup procedure and corresponding signaling; a no association based setup procedure; a negotiation procedure and corresponding signaling; a disassociation and teardown procedure; and a capability advertisement procedure.

Further, various embodiments of the present disclosure provide solutions for handling channel access for JTX, including: procedures to achieve start time synchronization for JTX; procedures for backoff hold time based start time synchronization; timing synchronization procedures based on service periods and start time boundary announcement; trigger based channel access mechanisms for JTX; procedures to stop ongoing downlink and uplink transmissions to enable JTX; coordinated channel access contention procedures for JTX; and capability advertisement procedures.

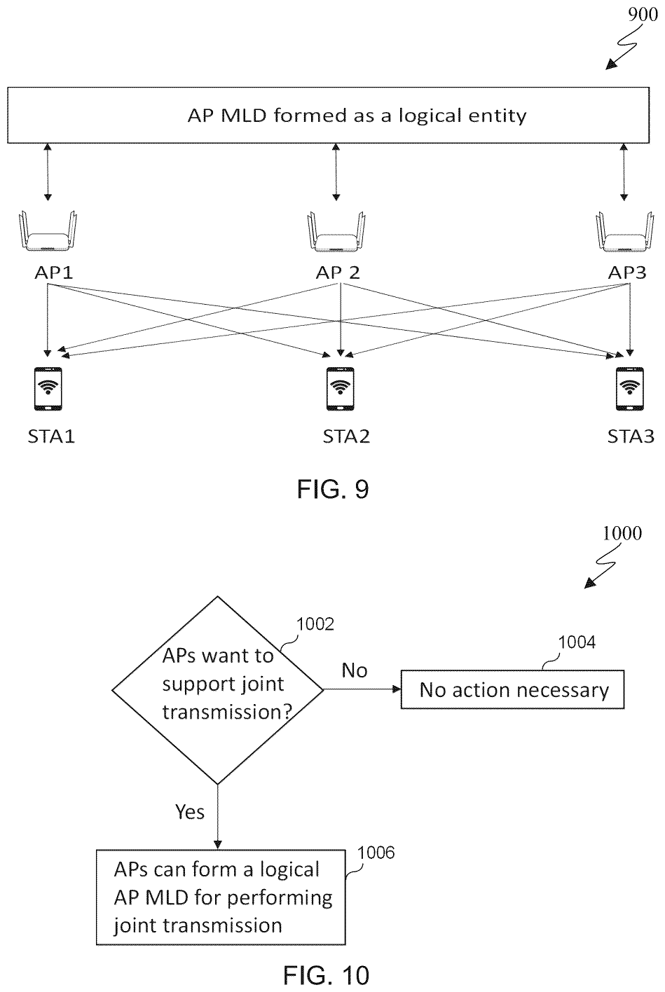

FIG. 9 illustrates an example of a joint transmission scheme based on a logical AP MLD setup 900 according to various embodiments of the present disclosure. The embodiment of a joint transmission scheme based on a logical AP MLD setup 900 shown in FIG. 9 is for illustration only. Other embodiments of a joint transmission scheme based on a logical AP MLD setup 900 could be used without departing from the scope of this disclosure.

According to one embodiment, the APs that want to perform joint transmission can form an AP MLD for the purpose of joint transmission as shown in FIG. 9. This AP MLD can be a logical/virtual entity rather than a physical entity.

FIG. 10 illustrates an example of a method 1000 for logical AP MLD formation for joint transmission according to various embodiments of the present disclosure. The embodiment of a method 1000 for logical AP MLD formation for joint transmission shown in FIG. 10 is for illustration only. Other embodiments of a method 1000 for logical AP MLD formation for joint transmission could be used without departing from the scope of this disclosure.

As illustrated in FIG. 10, the method 1000 begins at step 1002, where a determination is made whether the APs want to support joint transmission. If the APs do not want to support joint transmission, then no action is necessary as illustrated at step 1004. If the APs want to support joint transmission, then at step 1006, the APs can form a logical AP MLD for performing joint transmission.

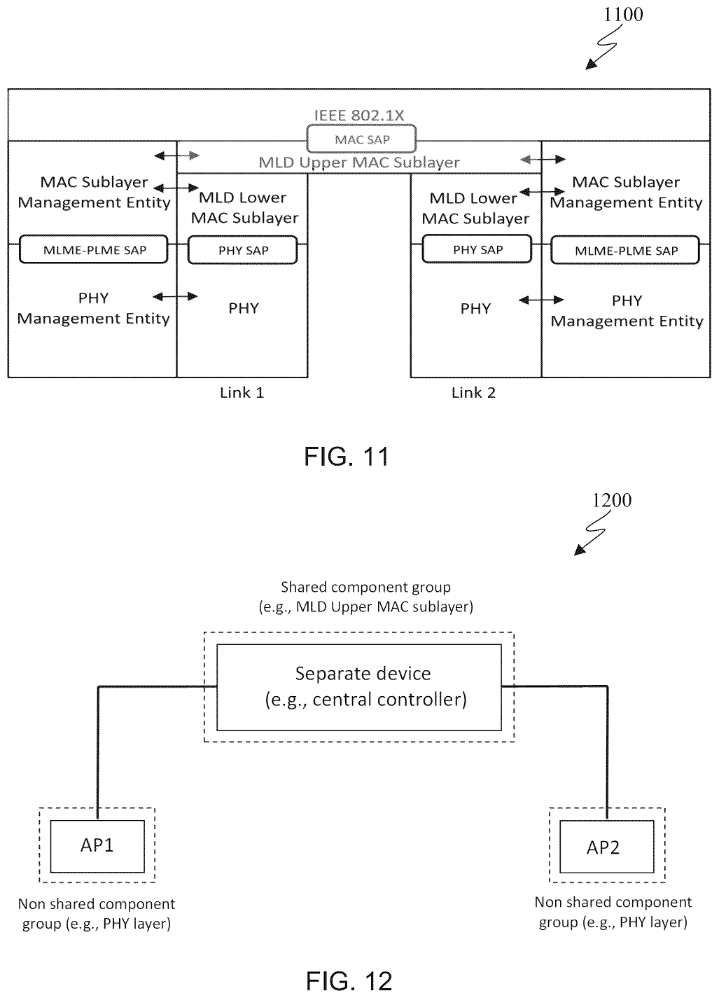

FIG. 11 illustrates an example of an architectural setup for a logical AP MLD for joint transmission 1100 according to various embodiments of the present disclosure. The embodiment of an architectural setup for a logical AP MLD for joint transmission 1100 shown in FIG. 11 is for illustration only. Other embodiments of an architectural setup for a logical AP MLD for joint transmission 1100 could be used without departing from the scope of this disclosure.

The logical AP MLD can have an architecture comprising of a physical layer, a MAC lower sub-layer and an upper MAC sub-layer. The architecture can be as depicted in FIG. 11 for the case of two APs.

FIG. 12 illustrates an example of a division of shared and non-shared component groups for the purpose of joint transmission 1200 according to various embodiments of the present disclosure. The embodiment of an example of a division of shared and non-shared component groups for the purpose of joint transmission 1200 shown in FIG. 12 is for illustration only. Other embodiments of an example of a division of shared and non-shared component groups for the purpose of joint transmission 1200 could be used without departing from the scope of this disclosure.

Various components of the logical AP MLD can be divided into two groups-a shared component group and a non-shared component group. The shared component group can perform functionalities that are common to all the APs that form the logical AP MLD (e.g., functionalities at the upper MAC sub-layer). The non-shared component group can perform functionalities that are specific to each AP (e.g., functionalities of the PHY layer).

The non-shared component group can be hosted on the AP itself (i.e., the physical device). The shared component group can be offloaded to any device that is connected to and can communicate with all the APs (e.g., a central controller). An example division of the shared and non-shared component group is as shown in FIG. 12.

According to one embodiment, both the upper and lower MAC sub-layer can be a part of the shared component group. Thus, the AP itself can have the PHY implemented while all lower MAC sub-layer functionalities can occur on the device hosting the shared component group. This division can be useful for cases where the network is customized for joint transmission. This can be useful for implementations wherein the AP is custom designed for joint transmission and carry only the necessary physical layer components.

According to another embodiment, the shared component group can be hosted/implemented on one of the APs that is participating in joint transmission. This AP can then coordinate with other APs either over the backhaul or over the air.

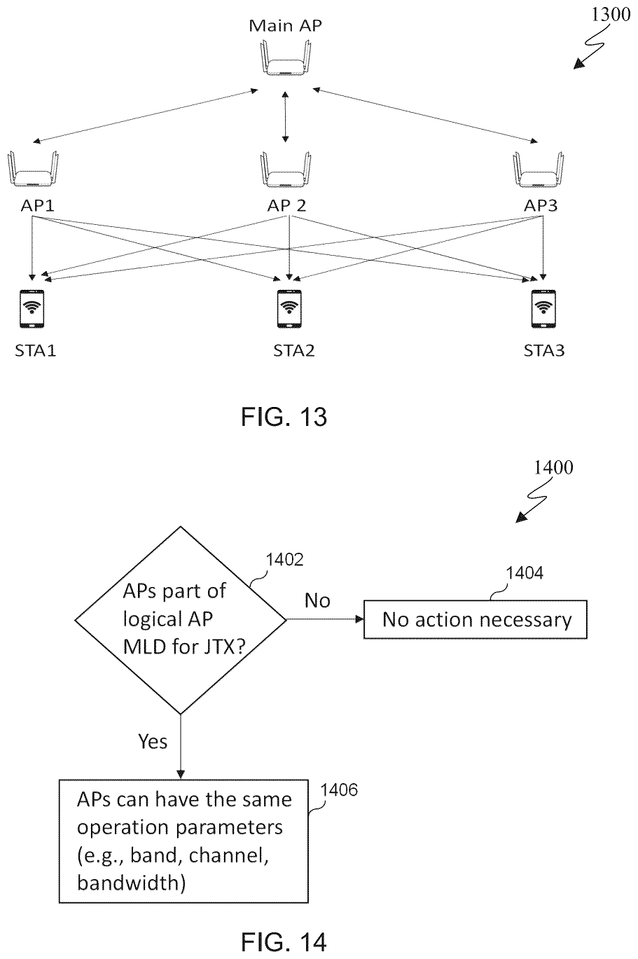

FIG. 13 illustrates a virtual AP setup example for joint transmission 1300 according to various embodiments of the present disclosure. The embodiment of a virtual AP setup example for joint transmission 1300 shown in FIG. 13 is for illustration only. Other embodiments of a virtual AP setup example for joint transmission 1300 could be used without departing from the scope of this disclosure.

According to one embodiment, there can be a main AP and a group of supporting APs that can form a virtual AP. As shown in FIG. 13, the main AP can coordinate with the supporting APs for the purpose of joint transmission. This coordination can include but is not limited to sharing data frames, triggering for data transmission, etc.

In another example, the main AP can also carry the shared components of the protocol stack while the supporting APs which are AP1-AP3 can carry the non-shared components of the protocol stack. Thus, the main AP and the supporting APs combined together can operate as a logical AP MLD.

According to one embodiment, the APs that participate in logical AP MLD formation for the purpose of joint transmission can have the same operation parameters.

FIG. 14 illustrates an example of a method 1400 for setting operation parameters for a JTX logical AP MLD according to various embodiments of the present disclosure. The embodiment of a method 1400 for setting operation parameters for a JTX logical AP MLD shown in FIG. 14 is for illustration only. Other embodiments of a method 1400 for setting operation parameters for a JTX logical AP MLD could be used without departing from the scope of this disclosure.

As illustrated in FIG. 14, the method 1400 begins at step 1402, where a determination is made whether the APs are part of a logical AP MLD for JTX. If the APs are not part of a logical AP MLD for JTX, then no action is necessary as illustrated at step 1404. If the APs are part of a logical AP MLD for JTX, then at step 1406, the APs can have the same operation parameters, for example, the same band, channel, and bandwidth.

According to one embodiment, the APs that participate in the logical AP MLD formation can have the same band, channel and bandwidth of operation. According to this embodiment, the APs that participate in the logical AP MLD formation can have the same band, channel and bandwidth of operation. Thus, all APs that are a part of the logical AP MLD can use the same band, channel and bandwidth. In one embodiment, the main AP/controller can announce the operation information by transmitting a message that can contain at least one or more of the information items as indicated in Table 1.1.

TABLE 1.1
Operation frequency announcement message

| Information | |
|---|---|
| item | Description |
| Operational | An information item that can describe the |
| channel | channel of operation (e.g., channel number) |
| Operation band | An information item that can describe the band |
| | of operation (e.g., the bandwidth) |
| Primary and non- | An information item that can indicate the |
| primary channel | primary and the non-primary channel information. |
| information | |

The above information items can be transmitted together or separately. They can be transmitted as a part of any existing frame/element/field/subfield in the standard or can be a part of newly defined ones.

Upon receiving this information from the main AP/controller, the APs participating in the JTX can configure their band and channel to the appropriate configuration.

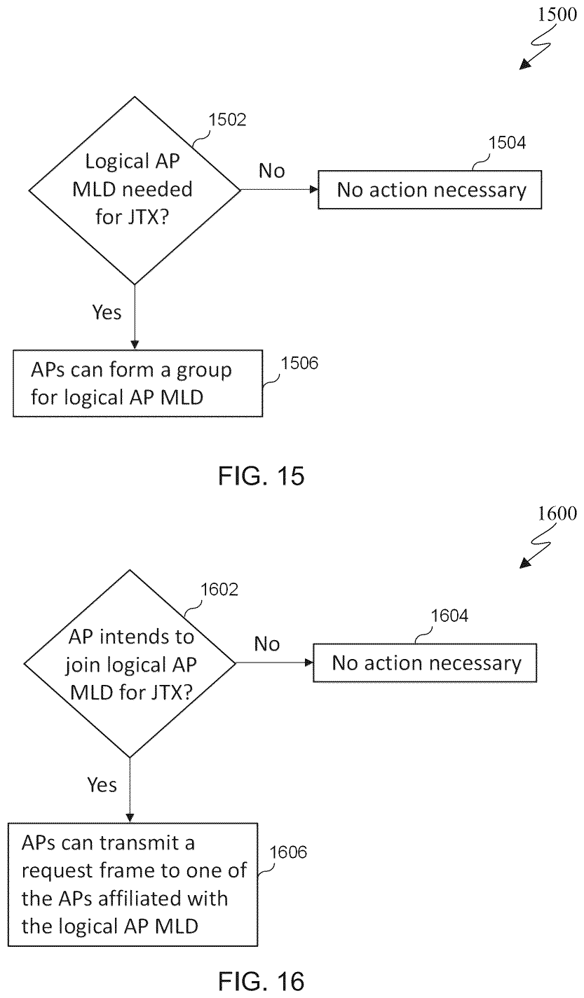

FIG. 15 illustrates an example of a method 1500 for group formation for a JTX logical AP MLD according to various embodiments of the present disclosure. The embodiment of a method 1500 for group formation for a JTX logical AP MLD shown in FIG. 15 is for illustration only. Other embodiments of a method 1500 for group formation for a JTX logical AP MLD could be used without departing from the scope of this disclosure.

As illustrated in FIG. 15, the method 1500 begins at step 1502, where a determination is made whether a logical AP MLD is needed for JTX. If a logical AP MLD is not needed for JTX, then no action is necessary as illustrated at step 1504. If a logical AP MLD is needed for JTX, then at step 1506, the APs can form a group for a logical AP MLD.

According to one embodiment, the logical AP MLD can be setup in implementation for the purpose of joint transmission and all APs can permanently be a part of it. According to another embodiment, the APs that intend to perform joint transmission can create a group and form a logical AP MLD as shown in FIG. 15. Therefore, different APs can dynamically join and leave the group.

According to one embodiment, one of the APs that operates as the main AP/controller can transmit a message to announce the secondary APs that can participate in JTX. This message may not be limited to the logical AP MLD setup and can be generally applicable to other setups as well (e.g., virtual AP setup). The message can contain at least one or more of the information items as indicated in Table 1.2 below.

TABLE 1.2
Information items that can be present in the announcement message

| Information | |
|---|---|
| items | Description |
| Secondary AP | An information item that can identify the secondary |
| identifier | AP(s) that can participate in the JTX (e.g., the AP |
| | MAC address, SSID, BSSID, etc.) |
| Duration | An information item that can indicate the duration |
| information | for which the JTX can occur (e.g., the transmission |
| | time of the PPDUs that can be transmitted in JTX). |
| Soft | An information item that can indicate if the secondary |
| recommendation | APs identified by the main AP must participate in JTX |
| | or can chose to opt out of the JTX group. |
| Traffic | An information item that can indicate the information |
| information | about the traffic type that can be served in the joint |
| | transmission (e.g., the TIDs, ACs, stream IDs, etc.) |
| Start time | An information item that can indicate the start time |
| information | of joint transmission. |
| Data sharing start | An information item that can indicate the time at |
| time information | which the data sharing can start. |

The above information items can be transmitted together or separately. They can be transmitted as a part of any existing frame/element/field/subfield in the standard or can be a part of newly defined ones.

According to one embodiment, the APs that are a part of the group can advertise the logical AP MLD in frames that they transmit (e.g., management frames). According to this embodiment, the STAs and neighboring APs that receive such frames can discover the logical AP MLD. According to another embodiment, the APs can receive the list of APs that are a part of the logical AP MLD by backhaul communication with the device that communicates and hosts the shared component group (e.g., central controller).

FIG. 16 illustrates an example of a method 1600 for an AP to join the logical APO MLD for JTX according to various embodiments of the present disclosure. The embodiment of a method 1600 for an AP to join the logical APO MLD for JTX shown in FIG. 16 is for illustration only. Other embodiments of a method 1600 for an AP to join the logical APO MLD for JTX could be used without departing from the scope of this disclosure.

As illustrated in FIG. 16, the method 1600 begins at step 1602, where a determination is made whether an AP intends to join a logical AP MLD for JTX. If an AP does not intend to join a logical AP MLD for JTX, then no action is necessary as illustrated at step 1604. If an AP intends to join a logical AP MLD for JTX, then at step 1606, the AP can transmit a request frame to one of the APs affiliated with the logical AP MLD.

According to one embodiment, the APs that are interested in joining the group can transmit a frame to one of the APs that are a part of the logical AP MLD/virtual AP to make this indication as shown in FIG. 16.

This frame can contain one or more of the information items indicated in Table 1.3.

TABLE 1.3
Information items that can be present in frame transmitted
by an AP for joining the logical AP MLD

| Information | |
|---|---|
| item | Description |
| Reason code | Reason code for sending the frame (e.g., a reason code |
| | indicating that the purpose is to join the logical AP |
| | MLD). |
| Associated | Information of all the STAs that are associated with the |
| STA | AP that intends to join the group (e.g., MAC address, |
| information | STA capabilities, etc.) |
| Intended start | The time at which the AP intends to be a part of the |
| time | group. The information can be indicated in terms of |
| | the beacon interval of the logical AP MLD. |
| Duration | Duration for which the AP intends to be a part of |
| | the logical AP MLD for JTX. |

Upon receiving the frame, if the logical AP MLD can accommodate the request of the AP, one of the APs affiliated with the logical AP MLD can transmit a response frame containing information shown in Table 2 to the AP.

TABLE 2
Information items that can be present in frame transmitted
by an AP affiliated with the logical AP MLD

| Information | |
|---|---|
| item | Description |
| Reason code | Reason code for sending the frame (e.g., a reason code |
| | approving the AP's request to join the logical AP MLD). |
| Start time | The time at which the AP can be a part of the group. |
| | The information can be indicated in terms of the beacon |
| | interval of the logical AP MLD. |
| Duration | Duration for which the AP can be a part of the logical |
| | AP MLD for JTX. |

According to one embodiment, an AP that intends to leave the group can inform the shared component group about its intention to leave the group. Following this, the AP can leave the group at the designated time.

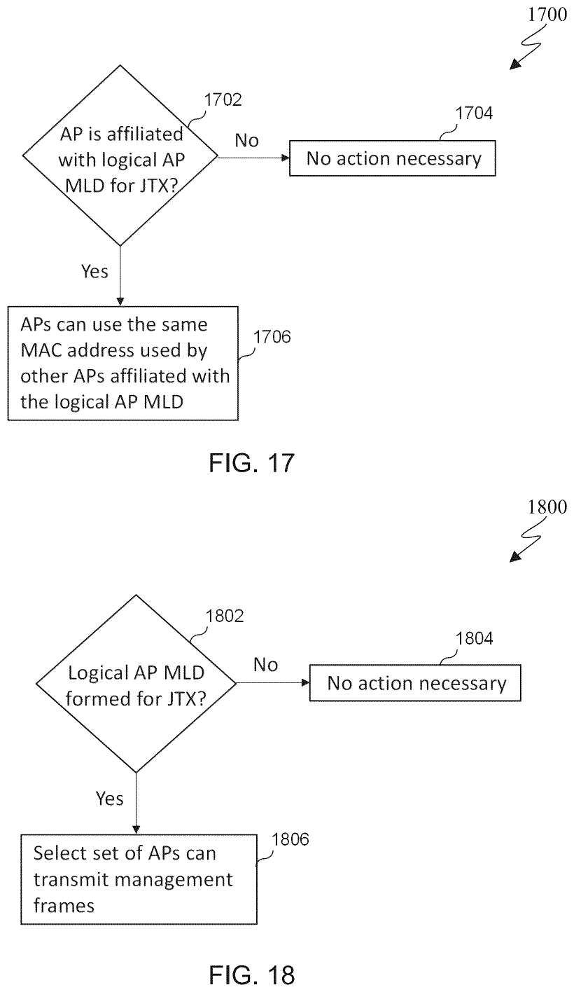

FIG. 17 illustrates an example of a method 1700 for APs that participate in JTX via logical AP MLD to advertise a MAC address used for communication according to various embodiments of the present disclosure. The embodiment of a method 1700 for APs that participate in JTX via logical AP MLD to advertise a MAC address used for communication shown in FIG. 17 is for illustration only. Other embodiments of a method 1700 for APs that participate in JTX via logical AP MLD to advertise a MAC address used for communication could be used without departing from the scope of this disclosure.

As illustrated in FIG. 17, the method 1700 begins at step 1702, where a determination is made whether an AP is affiliated with a logical AP MLD for JTX. If an AP is not affiliated with a logical AP MLD for JTX, then no action is necessary as illustrated at step 1704. If an AP is affiliated with a logical AP MLD for JTX, then at step 1706, the AP can use the same MAC address used by other APs affiliated with the logical AP MLD.

According to one embodiment, the APs that participate in joint transmission via logical AP MLD can advertise the same MAC address. Thus, for a STA they all appear to be a part of one AP with many antennas. Further, according to one embodiment, this MAC address can be an address that is specifically assigned for the purpose of joint transmission. According to another embodiment, this MAC address can be the address of one of the APs that is a part of the group. This AP can be required to never leave the group.

According to another embodiment, the APs that participate in the logical AP MLD can advertise different MAC addresses (e.g., their own individual MAC address).

FIG. 18 illustrates an example of a method 1800 for transmission of management frames by a set of APs affiliated with a logical AP MLD according to various embodiments of the present disclosure. The embodiment of a method 1800 for transmission of management frames by a set of APs affiliated with a logical AP MLD shown in FIG. 18 is for illustration only. Other embodiments of a method 1800 for transmission of management frames by a set of APs affiliated with a logical AP MLD could be used without departing from the scope of this disclosure.

As illustrated in FIG. 18, the method 1800 begins at step 1802, where a determination is made whether a logical AP MLD has been formed for JTX. If a logical AP MLD has not been formed for JTX, then no action is necessary as illustrated at step 1804. If a logical AP MLD has been formed for JTX, then at step 1806, a select set of APs from the AP MLD can transmit management frames.

According to one embodiment, the management frames can be transmitted by all the APs that are a part of the logical AP MLD.

According to another embodiment, only a select set of APs that are a part of the logical AP MLD can transmit management frames. As all APs use the same operation parameters, this can help to reduce the overhead of management frame transmission.

According to one embodiment, these APs can be determined by the shared component group such that all the STAs that are in a region can receive the management frames.

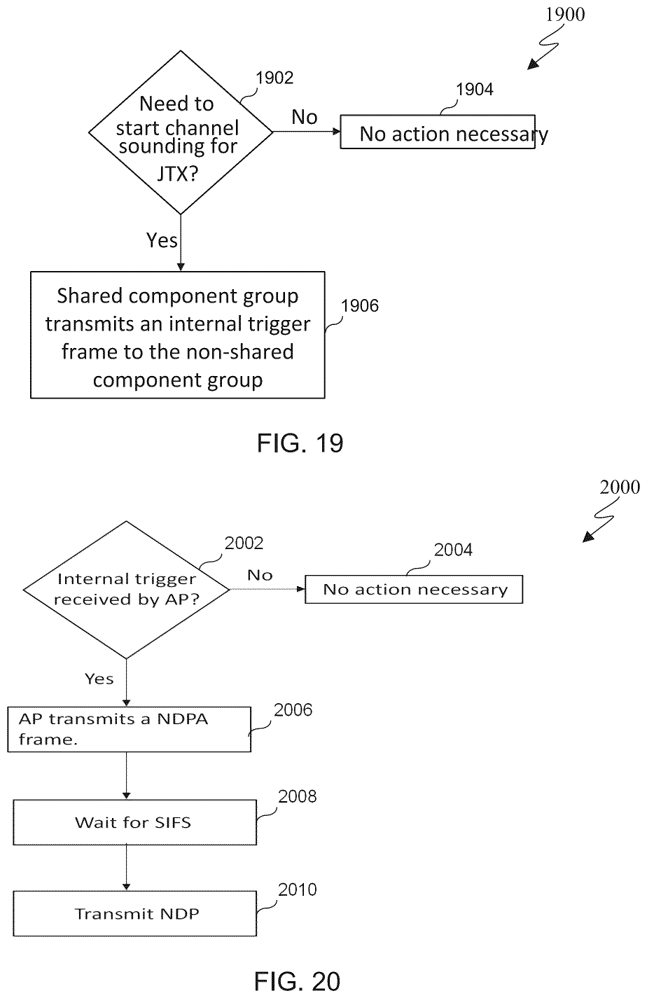

FIG. 19 illustrates an example of a method 1900 for a channel sounding initiation procedure according to various embodiments of the present disclosure. The embodiment of a method 1900 for a channel sounding initiation procedure shown in FIG. 19 is for illustration only. Other embodiments of a method 1900 for a channel sounding initiation procedure could be used without departing from the scope of this disclosure.

As illustrated in FIG. 19, the method 1900 begins at step 1902, where a determination is made whether there is a need to start channel sounding for JTX. If there is not a need to start channel sounding for JTX, then no action is necessary as illustrated at step 1904. If there is a need to start channel sounding for JTX, then at step 1906, a shared component group can transmit an internal trigger frame to a non-shared component group.

According to one embodiment, when channel sounding procedure is needed to be initiated, the shared component group/main AP can transmit an internal trigger to the non-shared component group for channel sounding procedure initiation as shown in FIG. 19.

The internal trigger can contain information that is necessary for initiating the sounding procedure. For instance, if the lower MAC sublayer is a part of the shared component group, it can generate the NDPA and NDP frames and pass those to the non-shared component group (which can comprise of PHY layer in this case) via the internal trigger. The internal trigger can be transmitted over the backhaul (e.g., if the device that implements the shared component group is the central controller) or it can be over the air (e.g., if the device that implements the shared component group is a part of one of the APs). When transmitted over the air, the information can either be transmitted in an independent frame or as part of the any of the frames existing in the standard (e.g., an existing trigger frames).

FIG. 20 illustrates an example of a method 2000 for a channel sounding procedure according to various embodiments of the present disclosure. The embodiment of a method 2000 for a channel sounding procedure shown in FIG. 20 is for illustration only. Other embodiments of a method 2000 for a channel sounding procedure could be used without departing from the scope of this disclosure.

As illustrated in FIG. 20, the method 2000 begins at step 2002, where a determination is made whether an internal trigger has been received by an AP. If an internal trigger has not been received by an AP, then no action is necessary as illustrated at step 2004. If an internal trigger has been received by an AP, then at step 2006, the AP can transmit a null data packet announcement (NPDA) frame. Then, at step 2008, the AP can wait for a short interframe space (SIFS). Thereafter, at step 2010, the AP can transmit the null data packet (NDP).

Upon receiving the internal trigger, the APs affiliated can transmit the NDPA frame followed by the NDP frame as shown in FIG. 20. The duration between the receipt of the internal trigger frame and the start of the NDPA frame can either be a fixed value (e.g., SIFS) or can be a value that is specified in the internal trigger itself.

According to another embodiment, upon receiving an internal trigger, one of the APs can transmit another trigger frame over the air to other APs affiliated with the logical AP MLD for computing parameters to enable joint transmission (e.g., CFO estimation, SFO for synchronization, etc.).

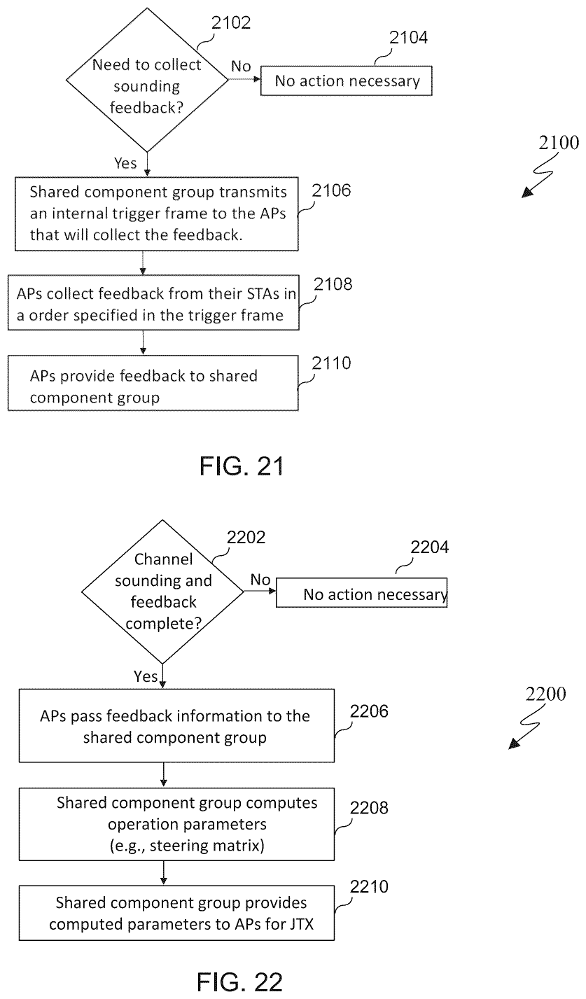

FIG. 21 illustrates an example of a method 2100 for a channel sounding feedback collection procedure according to various embodiments of the present disclosure. The embodiment of a method 2100 for a channel sounding feedback collection procedure shown in FIG. 21 is for illustration only. Other embodiments of a method 2100 for a channel sounding feedback collection procedure could be used without departing from the scope of this disclosure.

As illustrated in FIG. 21, the method 2100 begins at step 2102, where a determination is made whether there is a need to collect sounding feedback. If there is not a need to collect sounding feedback, then no action is necessary as illustrated at step 2104. If there is a need to collect sounding feedback, then at step 2106, the shared component group can transmit an internal trigger frame to the APs that will collect the feedback. Then, at step 2108, the APs can collect feedback from their STAs in an order specified in the trigger frame. Thereafter, at step 2110, the APs can provide feedback to the shared component group.

According to one embodiment, when channel sounding feedback (e.g., BF feedback, CQI feedback) needs to be collected from the STAs following the sounding procedure, the shared component group/main AP can transmit another internal trigger frame to the APs (either one of the APs that collects the feedback or all the APs if they collect their feedback). The APs can then collect feedback from the STAs in an order specified in the internal trigger frame. The procedure can be as shown in FIG. 21.

The internal trigger can be transmitted over the backhaul (e.g., if the device that implements the shared component group is the central controller) or it can be over the air (e.g., if the device that implements the shared component group is a part of one of the APs). When transmitted over the air, the information can either be transmitted in an independent frame or as part of the any of the frames existing in the standard (e.g., an existing trigger frames).

FIG. 22 illustrates an example of a method 2200 for a channel sounding feedback processing procedure according to various embodiments of the present disclosure. The embodiment of a method 2200 for a channel sounding feedback processing procedure shown in FIG. 22 is for illustration only. Other embodiments of a method 2200 for a channel sounding feedback processing procedure could be used without departing from the scope of this disclosure.

As illustrated in FIG. 22, the method 2200 begins at step 2202, where a determination is made whether channel sounding feedback is complete. If channel sounding feedback is not complete, then no action is necessary as illustrated at step 2204. If channel sounding feedback is complete, then at step 2206, the APs can pass feedback information to the shared component group. Then, at step 2208, the shared component group can compute the operation parameters (e.g., steering matrix). Thereafter, at step 2210, the shared component group can provide the computed parameters to the APs for JTX.

Upon receiving the feedback, the APs can transmit the information to the shared component group which can then compute the operation parameters necessary for performing joint transmission (e.g., steering matrix computation). The shared component group can then transmit this information to the APs.

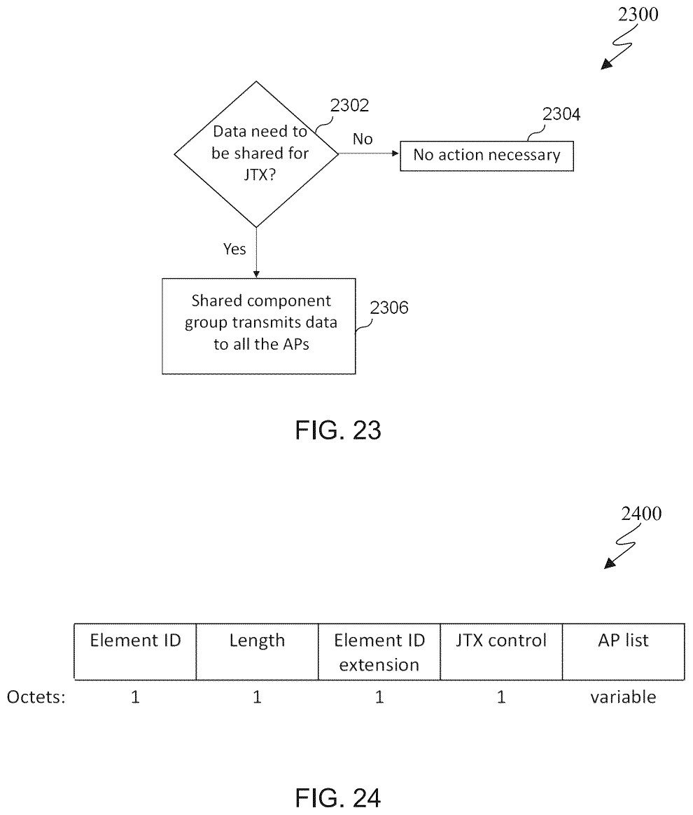

FIG. 23 illustrates an example of a method 2300 for a data sharing procedure for JTX according to various embodiments of the present disclosure. The embodiment of a method 2300 for a data sharing procedure for JTX shown in FIG. 23 is for illustration only. Other embodiments of a method 2300 for a data sharing procedure for JTX could be used without departing from the scope of this disclosure.

As illustrated in FIG. 23, the method 2300 begins at step 2302, where a determination is made whether data needs to be shared for JTX. If data does not need to be shared for JTX, then no action is necessary as illustrated at step 2304. If data needs to be shared for JTX, then at step 2306, the shared component group can transmit data to the APs.

For the purpose of joint transmission, the APs that participate need to share the data of the STAs with each other. According to one embodiment, for the purpose of JTX, the shared component group/main AP can share the data of the STAs that are a part of the multi-user group to be served on the downlink via JTX. The shared component group/main AP can either share the data with all the APs before the start of the channel sounding procedure (e.g., after sending the first internal trigger frame) or at a later point in time (e.g., after the sounding feedback has been collected by the device). Sharing the data at a later point in time can be useful if the lower MAC sub-layer is a part of the shared component group.

According to one embodiment, upon completion of data sharing, the main AP can transmit a trigger message to the supporting APs to start JTX. The trigger message can contain at least one or more of the information items as depicted in Table 3.

TABLE 3
Information items that can be present in the trigger message

| Information | |
|---|---|
| items | Description |
| Start time | An information item that can indicate the start time of |
| | JTX. This information item can also be implicitly conveyed |
| | by the reception of the trigger frame. Thus, the reception of |
| | the trigger frame from the main AP can indicate to the |
| | supporting APs to start JTX. |
| Supporting | An information item that can indicate the identifier of the |
| AP | supporting APs e.g., supporting AP MAC address, BSSID, |
| identifier | etc.) |
| Duration | An information item that can indicate the duration for |
| information | which the transmission can occur. |

The above information items can be transmitted together or separately. They can be transmitted as a part of any existing frame/element/field/subfield in the standard or can be a part of newly defined ones.

The trigger can also serve the purpose of achieving synchronization among the supporting APs for performing joint transmission.

According to one embodiment, an AP that is capable of forming logical AP MLD with other APs in the vicinity or an AP that has already formed a logical AP MLD with other APs for JTX can advertise this capability in management frames that it transmits (e.g., beacon, probe response frames, etc.). This information can help the STA to discover the framework and associate with it for joint transmission. The advertisement can be via an information item that can indicate the AP's capability to support JTX. For instance, there can be a capability bit/flag that can be set to a predetermined value (e.g., 1) to make the indication and to another predetermined value (e.g., 0) to indicate absence of the support.

According to another embodiment, the logical AP MLD framework can be torn down for a number of reasons. For instance, the backhaul latency prevents the operation of joint transmission using logical AP MLD. In such a scenario, the APs can fall back to their local stacks and teardown the logical AP MLD by sending a notification frame to the STA. Based on the notification frame, the STAs can disassociate from the logical AP MLD and associate with the local stack running on the AP.

The embodiments in this disclosure can also apply to other multi-AP coordination schemes (e.g., coordinated beamforming).

According to one embodiment, an STA that participates in JTX can explicitly associate with all the APs that are involved in JTX. This explicit association can establish the mapping required for the DS to route the packets of the STA to all the APs. Thus, the STA can be served via JTX by all the APs.

According to one embodiment, an AP can transmit a frame to the STA to inform the STA about the other APs that the STA can be served by via JTX. The frame transmitted by the AP to the STA can contain at least one or more of the information items as described in Table 4.

TABLE 4
Information items that can be present in the
frame transmitted by the AP to the STA

| Information | |
|---|---|
| item | Description |
| AP | An information item that can indicate the APs that |
| identifiers | participate in JTX along with the current AP (e.g., AP |
| | MAC addresses, a list of transmitted BSSIDs, etc.) |
| Reason | An information item that can indicate the reason for sending |
| information | this frame e.g., a reason code that can indicate that the |
| | reason for sending this frame is to indicate to the STA that |
| | it can associate with the above indicated APs if it wants to |
| | participate in JTX. |
| Response | An information item that can indicate if the AP needs a |
| requirement | response from the STA after it is connected to other APs |
| information | or not. |

The above information can be present in newly defined frames or in any of the frames existing in the standard. A few examples are below. The above information can also be in a single frame or split across multiple frames.

According to another embodiment, when the STA performs association with multiple APs, it can indicate to those APs that the association is only for the purpose of JTX. However, the main or the default AP that the STA can stay associated with for non-JTX operation (along with JTX operation) can still be the original AP. The STA can make such an indication to the other APs by transmitting a frame that can contain at least one or more of the information items as indicated in Table 5.

TABLE 5
Information items that can be present in the
frame transmitted by the STA to the AP

| Information | |
|---|---|
| item | Description |
| Default AP | An information item that can indicate the AP that the STA |
| identifier | is associated with for JTX and non-JTX purposes (e.g., the |
| | AP's MAC address, BSSID, etc.) |
| Default AP | An information item that can indicate that upon completion |
| notification | of the association procedure, the AP has to send an |
| | information to the default AP or the STA can do that. |
| JTX AP | An information item that can indicate the other APs that the |
| identifier | STA can associate with for JTX purposes only (e.g., a list |
| | of AP MAC addresses, BSSID, etc.) |

The above information can be present in newly defined frames or in any of the frames existing in the standard. A few examples are below. The above information can also be in a single frame or split across multiple frames.

FIG. 24 illustrates an example format of an element 2400 according to various embodiments of the present disclosure. The embodiment of the example format of an element 2400 shown in FIG. 24 is for illustration only. Other embodiments of the example format of an element 2400 could be used without departing from the scope of this disclosure.

According to one example, the above information in Table 4 can be carried in an element. The element can have a format as shown in FIG. 24.

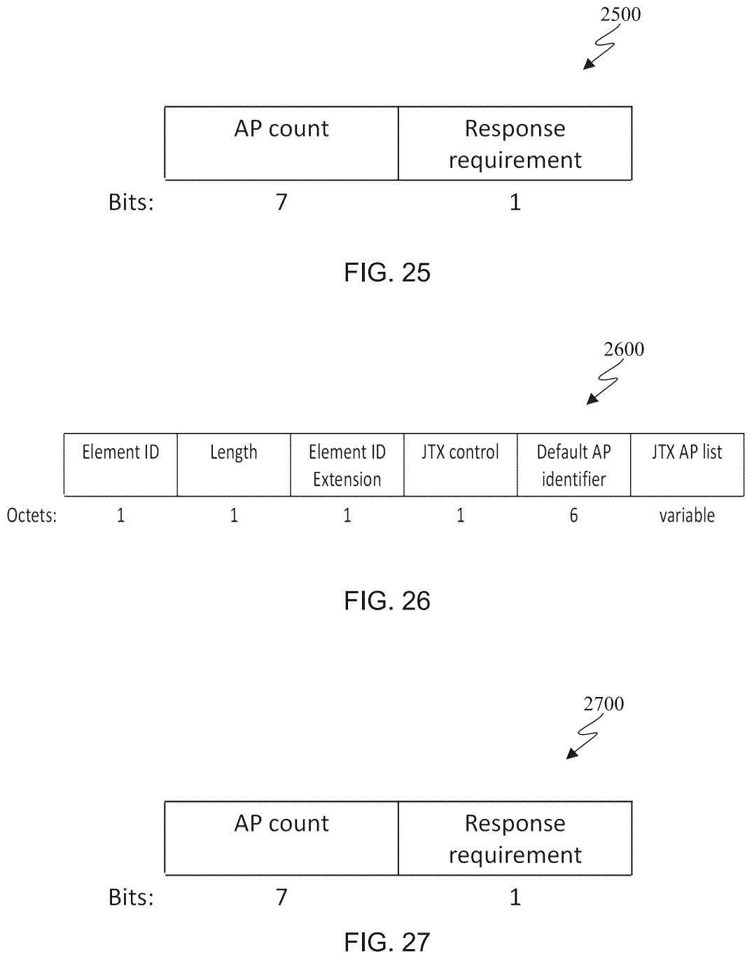

FIG. 25 illustrates an example format of a JTX control field format 2500 according to various embodiments of the present disclosure. The embodiment of the example format of a JTX control field format 2500 shown in FIG. 25 is for illustration only. Other embodiments of the example format of a JTX control field format 2500 could be used without departing from the scope of this disclosure.

The AP count subfield can indicate the number of APs whose identifiers are included in the AP list field.

The response requirement subfield can be set to a value of 1 if a response is required from the STA upon completion of association with the other APs and to 0 otherwise.

The AP list can carry AP identifiers (e.g., AP MAC address) for each of the AP that are participating or can participate in JTX for the particular STA.

FIG. 26 illustrates an example format of an element that the STA can transmit to other APS 2600 according to various embodiments of the present disclosure. The embodiment of the example format of an element that the STA can transmit to other APS 2600 shown in FIG. 26 is for illustration only. Other embodiments of the example format of an element that the STA can transmit to other APS 2600 could be used without departing from the scope of this disclosure.

According to one example, the information in Table 5 can be carried in an element in an element. The element can have a format as shown in FIG. 26.

FIG. 27 illustrates an example format of a JTX control frame 2700 according to various embodiments of the present disclosure. The embodiment of the example format of a JTX control frame 2700 shown in FIG. 27 is for illustration only. Other embodiments of the example format of a JTX control frame 2700 could be used without departing from the scope of this disclosure.

The JTX control frame can have a format as shown in FIG. 27. The AP count subfield can indicate the number of APs whose identifiers are listed in the JTX AP list.

The response requirement subfield can be set to 1 if the STA wants the AP to inform the default AP identified in the default AP identifier field in FIG. 26 that the STA has completed the association with the AP for JTX purposes. The subfield can be set to 0 otherwise.

The default AP identifier field indicates the default AP that the STA is associated with. The JTX AP list lists the other APs that the STA intends to associate with or has already associated with for the purpose of JTX.

Receipt of the element in FIG. 26 can indicate to the receiving AP that the STA is associating with the AP for the purpose of JTX transmissions only.

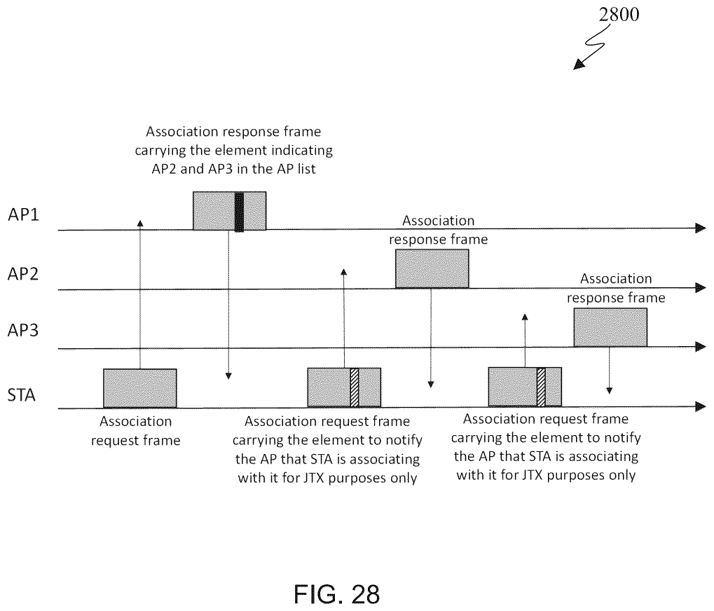

The above elements can be carried in any of the frames in the standard. An example operation using the above element in association request and response frames can be as shown in FIG. 28.

FIG. 28 illustrates an example operation 2800 using the element according to various embodiments of the present disclosure. The embodiment of the example operation 2800 using the element shown in FIG. 28 is for illustration only. Other embodiments of the example operation 2800 using the element could be used without departing from the scope of this disclosure.

As illustrated in FIG. 28, the STA starts an association procedure with AP1. Upon receiving the association request frame from the STA, the AP transmits an association response frame carrying the element. The AP list in the element indicates AP2 and AP3 as the APs that can participate in JTX along with AP1. Upon receiving an association response frame carrying the element from AP1, STA starts another association procedure with AP2 and AP3. In this association request frame, the STA can transmit an association request frame containing the element (described in Table 2) to the AP2 and AP3. Upon receiving the element, AP2 and AP3 can understand that the objective of association is solely for the purpose of JTX and that AP1 listed in the default AP identifier field of the element is the default AP that the STA is associated with. Upon completion of the procedure, the STA can be associated with AP1 for JTX and non-JTX purposes and with AP2 and AP3 for JTX purposes only. Thus, the DS can forward the relevant packets of the STA to AP2 and AP3 as well.

The APs can obtain the STA association ID from the default AP if necessary. Alternatively, the APs can assign an ID to the STA solely for the purpose of JTX.

The elements described above can also be carried in other management frames such as action frames after association is complete. An example action frame format can be as shown in Table 6.

TABLE 6
Action frame format for JTX

| Order | Information |
|---|---|
| 1 | Category |
| 2 | Protected Action |
| 3 | Dialog Token |
| 4 | Reason code |
| 5 | JTX element |

The category field indicates the category of the action frame.

The protected action field can enable to differentiate the protected action frame formats.

The dialog token can be a non-zero value that can be chosen by the transmitter of the frame to identify the request/response transaction.

The reason code can indicate the reason for transmitting the frame, e.g., as a request from the AP to the STA to request the STA to associate/connect with other APs for the purpose of JTX.

The JTX element can be the one illustrated in FIG. 24 or FIG. 26.

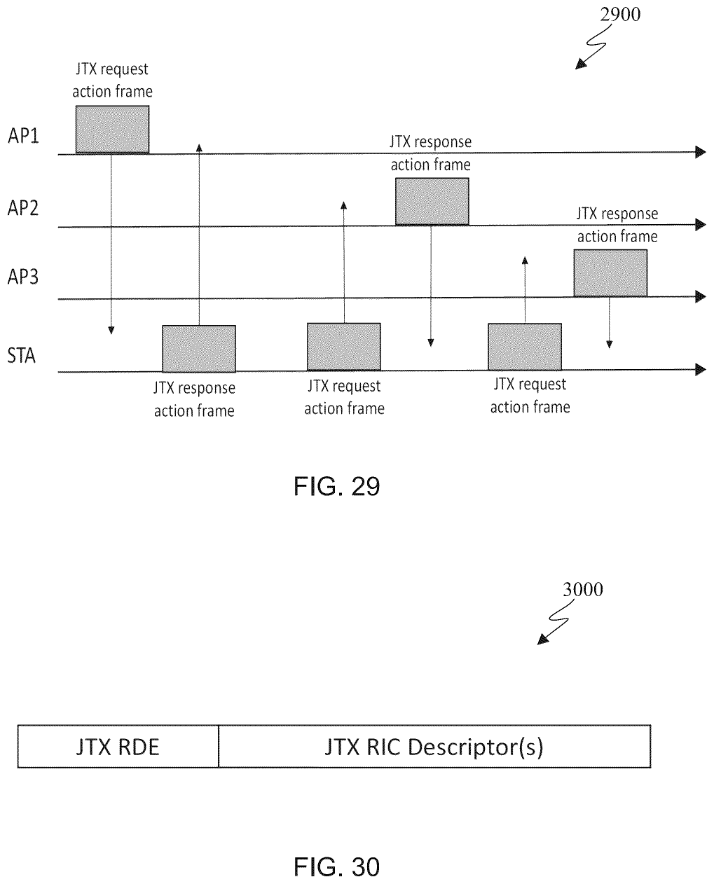

FIG. 29 illustrates an example operation 2900 using the action frame according to various embodiments of the present disclosure. The embodiment of the example operation 2900 using the action frame shown in FIG. 29 is for illustration only. Other embodiments of the example operation 2900 using the action frame could be used without departing from the scope of this disclosure.

As depicted, upon completion of association, AP1 transmits an action frame to STA containing the element in FIG. 24 to indicate to the STA that it should connect with AP2 and AP3 for the purpose of JTX. The intent of AP1 to transmit the element can be conveyed via the reason code. Upon receiving the element, STA can transmit another a response in an action frame. The response can carry the same dialog token as the request so that AP1 can understand the request that it corresponds to. STA can then send request action frames to AP2 and AP3 carrying the element in FIG. 26. AP2 and AP3 can understand the intent of the STA to transmit the action frame from the reason codes listed in those frames. Upon completion of the procedure, the STA can be associated with AP1 for JTX and non-JTX purposes and with AP2 and AP3 for JTX purposes only. Thus, the DS can forward the relevant packets of the STA to AP2 and AP3 as well.

According to one embodiment, an STA that intends to participate in JTX can inform the AP about its intention to participate in JTX during association. The STA can transmit an information item as a part of the association process that can indicate the STA's intention to participate in JTX after association. For example, a bit/flag that can be set to a predetermined value (e.g., 1) to indicate the intention to participate and to another predetermined value (e.g., 0) to indicate otherwise.

According to one embodiment, after association with an AP, the AP can assist the STA in associating/connecting to other APs that participate in JTX. According to this embodiment, after completion of the association procedure, the AP can inform other APs that can participate in JTX for that STA.

The frame transmitted by the AP can contain at least one or more of the information items as indicated in Table 7.

TABLE 7
Information items that can be present
in the frame transmitted by the AP

| Information | |
|---|---|
| item | Description |
| STA | An information item that can indicate any identifier |
| identifier(s) | for the STA that can be used for JTX (e.g., STA MAC |
| | address, association ID, any newly defined ID for |
| | JTX purposes). |
| Status | An information item that can indicate the status of |
| information | the STA's association with the transmitting AP, e.g., |
| | if the STA is associated with the AP or has it |
| | disassociated. |
| Other AP side | An information item to indicate if the other AP(s) have |
| status | updated the status of the STA or not. For example, this |
| | can be used if the information item is present in a |
| | response frame transmitted by the other APs to indicate |
| | that they have updated the status of the STA on their end. |

The above information item(s) can be present in a single frame or split across multiple frames. The above information items can be carried in newly defined frames or in any of the existing frames in the standard. Some examples can be as follows.

FIG. 30 illustrates an example JTX resource information container (RIC) frame format 3000 according to various embodiments of the present disclosure. The embodiment of the example JTX RIC frame format 3000 shown in FIG. 30 is for illustration only. Other embodiments of the example JTX RIC frame format 3000 could be used without departing from the scope of this disclosure.

In one example, the information items can be carried in a new resource information container (RIC). The RIC can have a format as shown in FIG. 30.

The information container can contain a resource descriptor element as described in Table 8.

TABLE 8
JTX RDE description

| Resource descriptor type | Meaning |
|---|---|
| 3 | JTX (dis)association information |

The JTX RIC descriptor can contain the information as shown in Table 9.

TABLE 9
Resource descriptor definition details

| | Resource | |
|---|---|---|
| Resource | descriptor | |
| descriptor | definition | |
| type | condition | Resource descriptor definition details |
| 3 | When in a | JTX identifier(s) (e.g., JTX specific AID), |
| | request | STA identifier(s), indication of association |
| | frame | or disassociation (e.g., a bit value), |
| | | indication that the STA can be served via |
| | | JTX involving the transmitting and receiving AP, |
| | | list of other APs that can be involved in JTX. |
| 3 | When in a | JTX identifier(s) (JTX specific AID), STA |
| | response | identifier(s), indication of association or |
| | frame | disassociation (e.g., a bit value), indication to |
| | | confirm that the STA info has been updated at the |
| | | receiver and ready for JTX related communication |
| | | (e.g., a bit value), indication that the STA can be |
| | | served via JTX involving the transmitting and |
| | | receiving AP, list of other APs that can be |
| | | involved in JTX. |

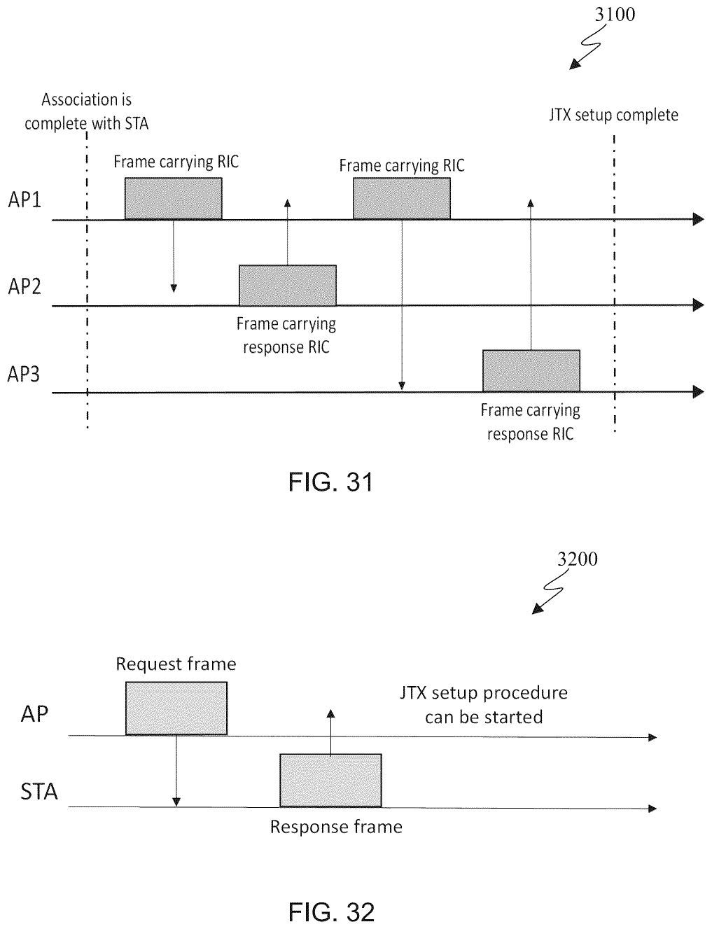

FIG. 31 illustrates an example operation 3100 using the RIC according to various embodiments of the present disclosure. The embodiment of the example operation 3100 using the RIC shown in FIG. 31 is for illustration only. Other embodiments of the example operation 3100 using the RIC could be used without departing from the scope of this disclosure.

As illustrated in FIG. 31, upon completion of association with STA, AP1 which is the default AP transmits a frame carrying an RIC providing the information items indicated in Table 6 for a request frame to AP2 and AP3. Upon receiving the request frames, each of the APs transmit a frame carrying a response RIC. After the connection for the STA at each of the AP is setup, the JTX setup procedure is complete.

According to one embodiment, the device can perform only authentication as a part of its initial setup and skip association. Thus, each STAs frame can be mapped by the DS to each AP in the network. As a result, each AP can have the STAs frames. APs that can hear an STA can serve it via JTX.

According to one embodiment, there can be a negotiation procedure. As a part of the negotiation procedure, the STA can indicate to the AP that it wants to participate in JTX. Thereafter, the AP and/or the STA can perform necessary setup for JTX (by using any of the procedures described in this disclosure).

During the negotiation an entity (can be either AP or the STA) can transmit a negotiation request frame to the other entity (STA or AP). Upon receiving the negotiation request frame, the other entity can transmit a negotiation response frame to provide its response to the requesting entity.

The request frame can contain at least one or more of the information items as indicated in Table 10.

TABLE 10
Information items that can be present
in the negotiation request frame

| Information | |
|---|---|
| items | Description |
| Request | An information item that can indicate that this is a |
| indication | negotiation request for JTX setup (e.g., a reason code). |
| Response | An information item that can indicate that this |
| requirement | negotiation request requires a response. For example, |
| | a field (e.g., a bit) that can take a predetermined value |
| | (e.g., 1) to indicate the requirement. |
| JTX setup | An information item that can indicate the details of the |
| details | JTX setup. For example, a list of participating APs, etc. |
| | This item can be present in the request if the requesting |
| | entity is the AP. |
| Request | An information item that can serve as a reference to this |
| identifier | request (e.g., a dialog token) |

The above information can be present in a single frame or in more than one frames. The above information items can be carried in newly defined frames or in any of the frames existing in the standard.

The response frame can contain at least one or more of the information items as indicated in Table 11.

TABLE 11
Information items that can be present
in the negotiation response frame

| Information | |
|---|---|
| item | Description |
| Response | An information item that can describe the response from |
| indication | the responding entity (e.g., a status code). |
| Request | An information item that can serve as a reference to |
| identifier | this request (e.g., a dialog token) |
| JTX setup | An information item that can indicate the details of |
| details | the JTX setup. For example, a list of participating APs, etc. |
| | This item can be present in the request if the responding |
| | entity is the AP. |

The above information can be present in a single frame or in more than one frames. The above information items can be carried in newly defined frames or in any of the frames existing in the standard.

FIG. 32 illustrates an example operation 3200 using the request and response frame according to various embodiments of the present disclosure. The embodiment of the example operation 3200 using the request and response frame shown in FIG. 32 is for illustration only. Other embodiments of the example operation 3200 using the request and response frame could be used without departing from the scope of this disclosure.

An example operation using the request and response frame can be as shown in FIG. 32. The AP sends a negotiation request frame to the AP providing an indication that the request is for JTX setup. The STA transmits a response frame. Upon receiving the response frame indicating a positive response, the JTX setup procedures (e.g., such as those described above in this disclosure) can be started.

When the STA disassociates with its default AP, either the AP or the STA can start teardown procedure for the JTX setup. If the AP starts the teardown procedure, the AP can transmit an RIC to other APs in the JTX setup to inform them about the disassociation and start the teardown. If the STA starts the teardown procedure, the STA can inform the other AP in the JTX setup about the disassociation and initiate the teardown.

According to one embodiment, an AP/AP MLD or a STA/non-AP MLD that supports JTX or any of the procedures for JTX described in this disclosure can advertise their support for the feature and/or the procedure in one or more frames that they transmit. If an AP/AP MLD supports JTX or any of the procedures for JTX then it can advertise its capabilities in one or more frames that it transmits. In one example, these frames can be management frames such as beacons, probe responses, (Re)association responses, etc. There can be a field (e.g., a bit) which can take a predetermined value (e.g., 1) to indicate the support and another predetermined value (e.g., 0) to indicate that the support is not present. If a STA/non-AP MLD supports JTX or any of the procedures for JTX then it can advertise its capabilities in one or more frames that it transmits. In one example, these frames can be management frames such as probe requests, (Re)association requests, etc. There can be a field (e.g., a bit) which can take a predetermined value (e.g., 1) to indicate the support and another predetermined value (e.g., 0) to indicate that the support is not present.

The above procedures can also be used for non-JTX related purposes wherever applicable and are not to be considered as limited to JTX.

The above procedures can also be used in architectures such as the logical AP MLD architecture when applicable.

The information items indicated in this disclosure can be carried in any of the frames in the standard.

Although the description in this disclosure is given in the context of AP and STA, it can also apply to multi-link operation.

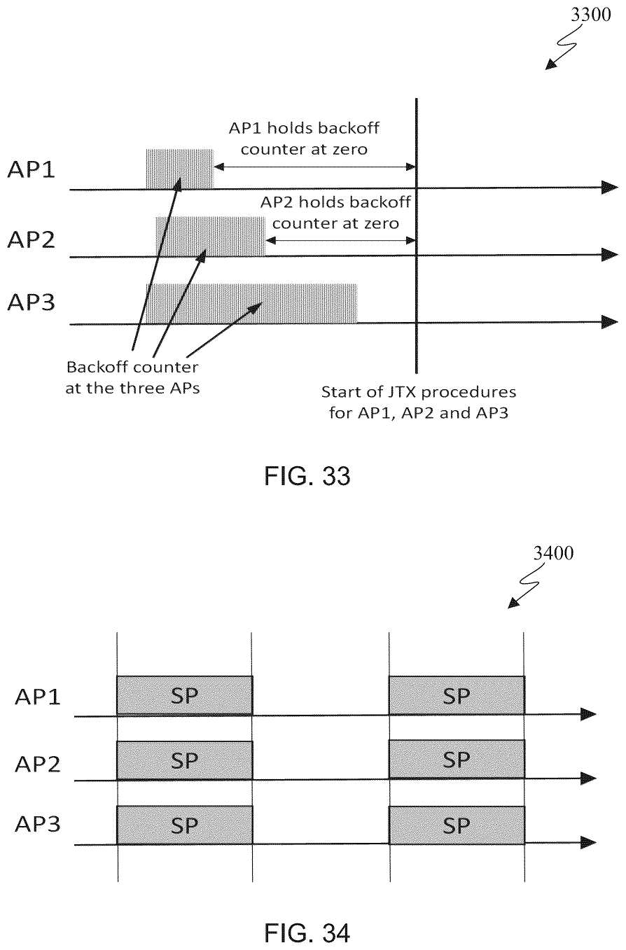

FIG. 33 illustrates an example backoff hold time procedure 3300 according to various embodiments of the present disclosure. The embodiment of the example backoff hold time procedure 3300 shown in FIG. 33 is for illustration only. Other embodiments of the example backoff hold time procedure 3300 could be used without departing from the scope of this disclosure.

According to one embodiment, a backoff hold time procedure can be followed for JTX. According to this embodiment, one or more APs involved in JTX can hold their backoff counter(s) at zero in order to be able to access the channel at the same time. Thus, when the backoff counter of an AP reaches zero, it can choose to not transmit and keep its backoff at zero and then initiate a transmission when the backoff counters of other APs also reaches zero. When following this procedure, each of the APs can ensure that the EDCA rules for each of the AP permit them the access to the medium at the time of issuance of PHY-TXSTART.request for that particular link. If medium for one of the APs becomes busy, then either the AP can ensure that it can make the medium idle again (e.g., by using the procedures described in sec. 4) or it can start a new backoff procedure using the EDCA rules. Alternatively, the AP can also defer transmissions.

An example can be as shown in FIG. 33. AP1, AP2 and AP3 are three APs that perform JTX. Each AP is contending to gain channel access. When the backoff counter of AP1 reaches zero, the backoff counter of AP2 and AP3 has not reached zero. AP1 can hold the backoff counter at zero in order to be able to perform JTX along with AP2 and AP3. When AP2's backoff counter reaches zero, AP2 can also hold the backoff counter to be able to perform JTX with AP1 and AP3. When AP3's backoff counter reaches zero, JTX can be initiated.

The APs can understand the remaining backoff counter of other APs by exchanging the information with each other. Thus, each AP can provide and/or request the remaining backoff counters at the other APs. This can either be done using an over the air procedure or by exchanging the information over the backhaul/wired network (e.g., through the central controller).

When the information is requested over the air, it can be done by transmission of a frame that can contain at least one or more of the information items as indicated in Table 12 and can be done in a cross link manner i.e., the information can be exchanged on other links of the AP MLD in case of MLO operation.

TABLE 12
information items that can be present for
backoff counter information exchange

| Information | |
|---|---|
| item | Description |
| AP identifier | An information item that can identify the AP for which |
| | this information corresponds to (e.g., AP MAC address |
| | with or without the link ID). |
| Timing | An information item that can describe the time at which |
| information | the information was generated (e.g., a timestamp). The |
| | recipient can then recompute the remaining backoff counter |
| | value by computing the elapsed time from the time the |
| | information is generated. |
| Backoff | An information item that can provide information on the |
| counter | backoff counter value (e.g., remaining slots for each AC). |
| value | |

The above information can be present in one frame or distributed across multiple frames. The above information can be present in existing frames or in newly defined frames in the standard.

The APs can also increase the likelihood of being able to access the channel at the same time by following some mechanisms to ensure that the chances of them gaining channel access at the same time is higher.

FIG. 34 illustrates an example TWT SP alignment operation 3400 according to various embodiments of the present disclosure. The embodiment of the example TWT SP alignment operation 3400 shown in FIG. 34 is for illustration only. Other embodiments of the example TWT SP alignment operation 3400 could be used without departing from the scope of this disclosure.

According to one embodiment, each AP can ensure that its TWT service periods (SPs) are aligned in time with those of the other APs to increase the likelihood for synchronized JTX transmission in those SPs. This can increase the likelihood of synchronizing the JTX start times for each of the APs with those of the others. In order to achieve this, each AP can communicate their SP start times to other APs involved in JTX. As the TSF timer at different APs can be different, the APs that participate in JTX can synchronize their TSF timers in order to be able to exchange and interpret timing related information correctly. Alternatively, each AP can correct the start time of SPs that are provided or announced by other APs. An example can be depicted in FIG. 9 where the SPs are synchronized for increasing the likelihood of being able to access the channel for JTX at the same time. This can be applicable for TWT or its variants (e.g., rTWT, bTWT, etc.)

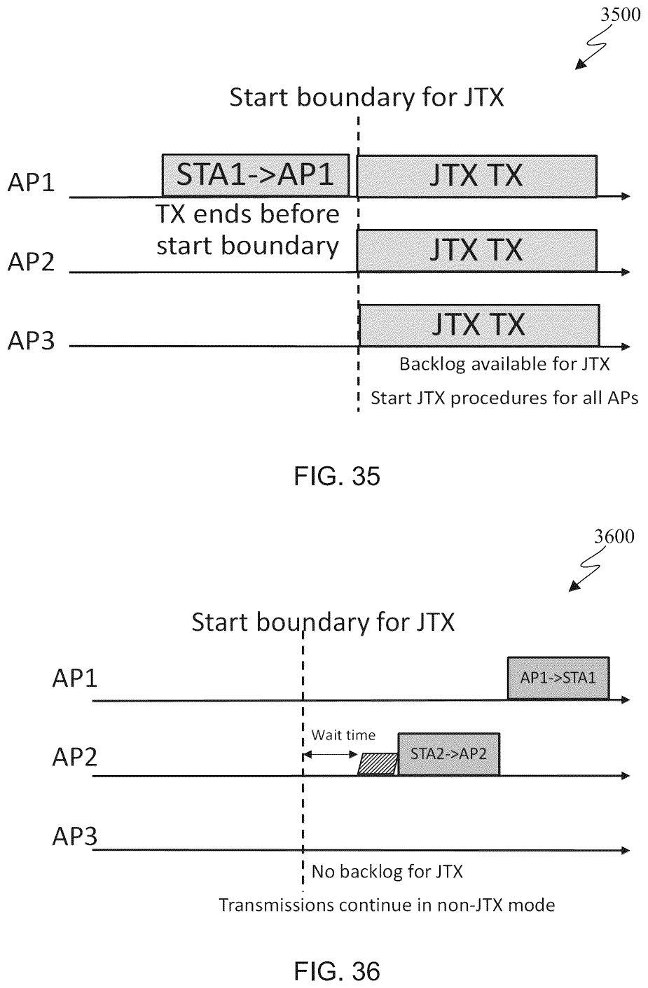

FIG. 35 illustrates an example start time boundary operation 3500 according to various embodiments of the present disclosure. The embodiment of the example start time boundary operation 3500 shown in FIG. 35 is for illustration only. Other embodiments of the example start time boundary operation 3500 could be used without departing from the scope of this disclosure.

According to another embodiment, a JTX start time boundary can be defined and announced. APs can coordinate among each other and determine the start time boundaries. JTX can be started at the start time boundary. Other devices can stop their transmission prior to the start time boundary. If JTX does not start within a certain amount of time (e.g., a predetermined wait time) following the start time boundary, then other non-JTX transmissions can be initiated. An example can be as shown in FIG. 35. As depicted, STA1 is transmitting to AP1 and ends its transmission prior to the start time boundary. At the start time boundary, AP1, AP2 and AP3 start the JTX procedures.

FIG. 36 illustrates another example start time boundary operation 3600 according to various embodiments of the present disclosure. The embodiment of the example start time boundary operation 3600 shown in FIG. 36 is for illustration only. Other embodiments of the example start time boundary operation 3600 could be used without departing from the scope of this disclosure.

In another example shown in FIG. 36, at the start time boundary, a backlog is not available for JTX. Therefore, after the threshold of wait time is exceeded following the start time boundary, other non-JTX transmissions are initiated.

In order to announce the start times, the AP can announce the start times in a frame that it transmits (e.g., a management frame such as a beacon). Devices that receive such a frame can understand the start time boundaries and follow them.

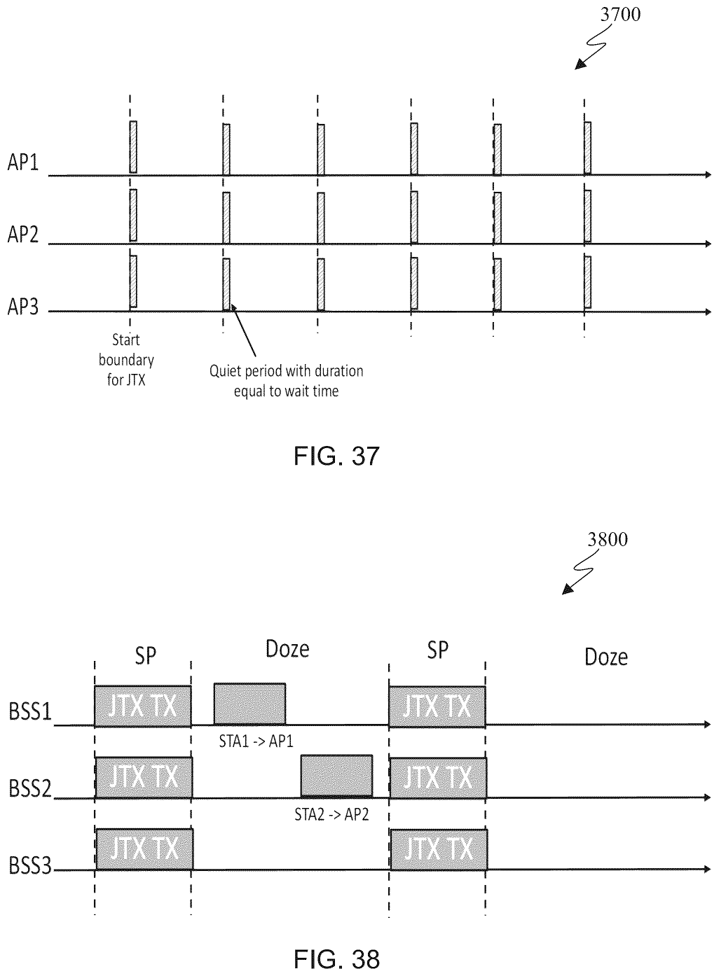

FIG. 37 illustrates an example quiet element based start time boundary operation 3700 according to various embodiments of the present disclosure. The embodiment of the example quiet element based start time boundary operation 3700 shown in FIG. 37 is for illustration only. Other embodiments of the example quiet element based start time boundary operation 3700 could be used without departing from the scope of this disclosure.

In one embodiment, the AP can create start time boundaries by creating quiet periods by using the quiet element (such as those announced in beacons). The duration of the quiet period in such announcements can be set to the wait time. Further, there can also be an indication that can indicate that the quiet element is creating start time boundaries for JTX so that the STAs can stay awake for reception. An example is as shown in FIG. 37.

FIG. 38 illustrates an example of a dedicated SP for JTX operation 3800 according to various embodiments of the present disclosure. The embodiment of the example of a dedicated SP for JTX operation 3800 shown in FIG. 38 is for illustration only. Other embodiments of the example of a dedicated SP for JTX operation 3800 could be used without departing from the scope of this disclosure.

According to one embodiment, there can be a dedicated TWT (rTWT, bTWT, etc.) schedule for JTX. During the setup of such a TWT an indication can be provided to the recipient that this TWT schedule is meant for JTX. All the APs can ensure that they have the same TWT schedule in their own BSS for JTX. The schedule can be created either via a communication between the APs. An example can be as shown in FIG. 38.

According to another embodiment, during rTWT SPs, the JTX APs can ignore the quiet period and start JTX at the start boundary of the SP.

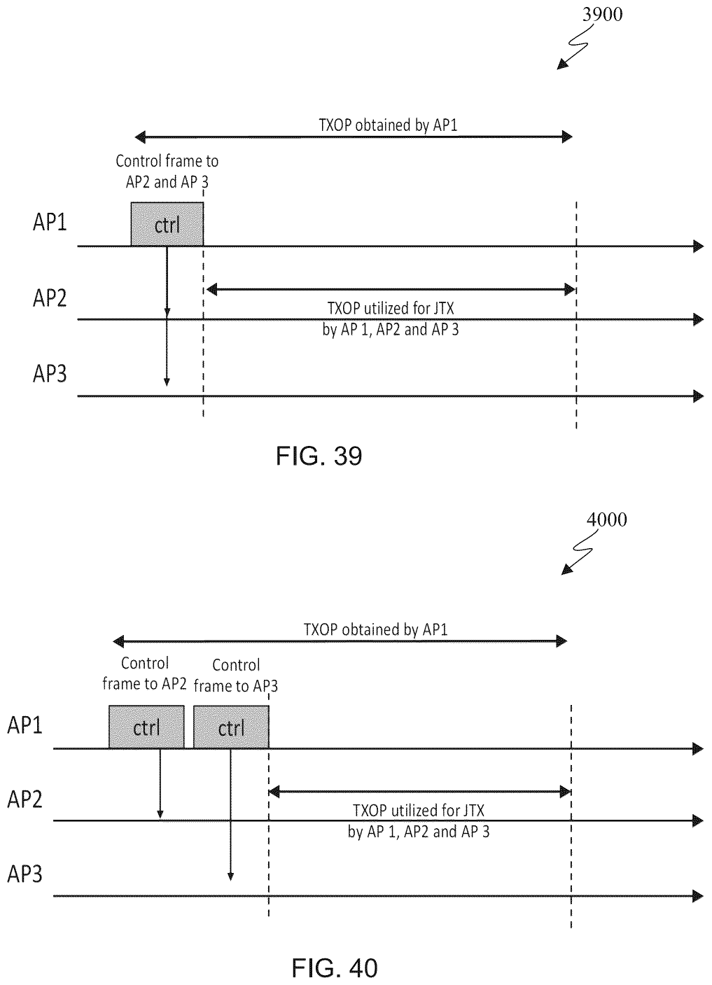

FIG. 39 illustrates an example depicting a triggered JTX operation 3900 according to various embodiments of the present disclosure. The embodiment of the example depicting a triggered JTX operation 3900 shown in FIG. 39 is for illustration only. Other embodiments of the example depicting a triggered JTX operation 3900 could be used without departing from the scope of this disclosure.

According to one embodiment, when one of the APs that participates in JTX obtains channel access, it can share its entire TXOP or a portion of it with the other APs. However, instead of dividing the TXOP amongst the other APs, the entire TXOP or a portion of it can be used by all the APs at the same time. An example is shown in FIG. 39 where the entire TXOP is shared with the other APs.

FIG. 40 illustrates another example depicting a triggered JTX operation 4000 according to various embodiments of the present disclosure. The embodiment of the example depicting a triggered JTX operation 4000 shown in FIG. 40 is for illustration only. Other embodiments of the example depicting a triggered JTX operation 4000 could be used without departing from the scope of this disclosure.

As shown in the example, upon winning channel access, AP1 transmits a control frame to AP2 and AP3. This can either be a single control frame or AP1 can transmit two control frames-one to AP2 and the other to AP3 as shown in FIG. 40.

Upon receiving the control frames, the entire TXOP is utilized by AP1, AP2 and AP3 for JTX operation. The control frame can be a newly defined frame or any of the frames existing in the standard (e.g., MU-RTS TXS frame). The control frame can contain at least one or more of the information items as indicated in Table 13.

TABLE 13
Information items that can be present in the control frame

| Information | |
|---|---|
| item | Description |
| AP | An information item that can indicate the AP(s) that the |
| identifier | TOXP is being shared with. These can be the APs that can |
| | be involved in JTX operation (e.g., an AP identifier, |
| | MAC addresses, transmitted BSSIDs, etc.) |
| JTX | An information item that can indicate that the allocated |
| indication | portion will be utilized for JTX operation. For example, |
| | this can be a field (such as a bit) that can take a pre-, |
| | determined value (e.g. 1) to indicate that this allocation is |
| | for JTX. In another example, this can also be a reason code. |
| Time and | An information item that can describe the time (e.g., time |
| frequency | from when the TXOP is shared for JTX) and frequency |
| allocation | (e.g., the bandwidth that is being shared for JTX purposes) |
| | resources that are being shared by the AP that won the |
| | contention. |

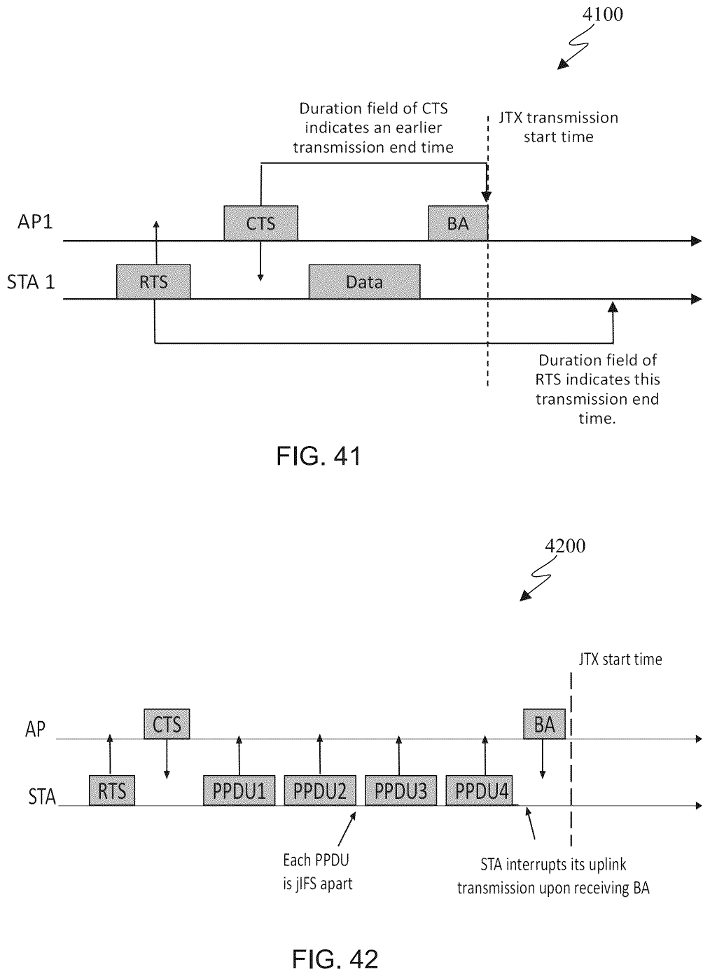

FIG. 41 illustrates an example operation 4100 to shorten the transmission time of uplink transmission according to various embodiments of the present disclosure. The embodiment of the example operation 4100 to shorten the transmission time of uplink transmission shown in FIG. 41 is for illustration only. Other embodiments of the example operation 4100 to shorten the transmission time of uplink transmission could be used without departing from the scope of this disclosure.

According to one embodiment, to start JTX across multiple APs, some of the APs may need to stop their ongoing downlink or uplink transmissions to participate in JTX.

According to one embodiment, if an AP is close to a JTX transmission start time and a transmission request for uplink transmission is received, then the AP can reduce the TXOP in its response such that the transmission ends before JTX start time or expected start time. An example is as shown in FIG. 16. As depicted, an STA transmits an RTS to the AP and the duration field of the RTS indicates that the transmission time does not end before the JTX start time. The AP can respond with a CTS with a reduced duration field such that the new transmission time ends before the JTX start time. Thus, the AP can shorten the transmission time of uplink transmission to end before the JTX start time.

FIG. 42 illustrates an example early termination operation 4200 to stop uplink transmission according to various embodiments of the present disclosure. The embodiment of the example early termination operation 4200 to stop uplink transmission shown in FIG. 42 is for illustration only. Other embodiments of the example early termination operation 4200 to stop uplink transmission could be used without departing from the scope of this disclosure.

According to one embodiment, the STA can divide its transmission into smaller PPDUs which can be transmitted at a certain interframe spacing (jIFS). If the transmission does not end before the JTX transmission start time, then the AP can transmit a frame after the completion of the nearest PPDU to stop the uplink transmission. An example can be as shown in FIG. 42. As depicted, the AP transmits a BA prior to the start of PPDU5 to end the uplink transmission prior to the JTX start time.

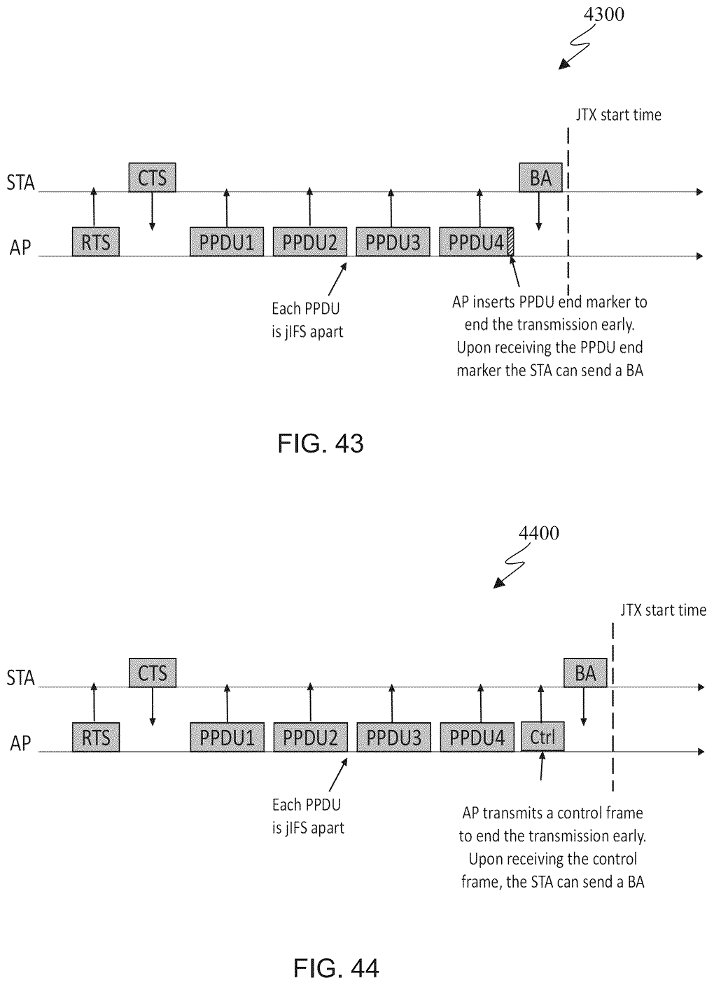

FIG. 43 illustrates an example early termination operation 4300 to stop downlink transmission according to various embodiments of the present disclosure. The embodiment of the example early termination operation 4300 to stop downlink transmission shown in FIG. 43 is for illustration only. Other embodiments of the example early termination operation 4300 to stop downlink transmission could be used without departing from the scope of this disclosure.

According to one embodiment, the AP can divide its transmission into smaller PPDUs and insert a PPDU end marker at the end of the PPDU that is closest to the JTX transmission start time. Upon receiving a PPDU with a PPDU end marker, the STA transmit a BA to end the transmission early. An example is as shown in FIG. 43.

FIG. 44 illustrates another example early termination operation 4400 to stop downlink transmission according to various embodiments of the present disclosure. The embodiment of the example early termination operation 4400 to stop downlink transmission shown in FIG. 44 is for illustration only. Other embodiments of the example early termination operation 4400 to stop downlink transmission could be used without departing from the scope of this disclosure.

In another embodiment, the AP can transmit another frame (e.g., a control frame) to indicate the early completion of the downlink transmission instead of inserting a PPDU end marker as shown in the example in FIG. 44.

According to one embodiment, when contending for JTX, if different APs obtain channel access for different ACs, then one AC can be chosen across all the APs for performing JTX. This AC can be chosen based on a criterion such as an AC which has in its queues high priority frames (e.g., frame whose delay bounds can get exceeded first), frames with the strictest QOS requirements, etc.

According to one embodiment, when one AP wins the channel access it can notify other APs and they can stop their ongoing uplink or downlink transmission and join JTX transmission.

According to one embodiment, when contending for channel access to perform JTX, one of the APs can perform the contention and backoff procedure on behalf of the other APs. When the AP completes its backoff procedure, if the channel is idle for all the APs, then JTX can be initiated. If channel is not idle for at least one or more of the APs, then all the APs can defer for a period of time that is equal to the maximum of the channel busy time across all the APs. According to one embodiment, the backoff timers can be maintained at the central controller and each of the individual APs can report their channel states to the central controller. When the channel is idle for all the APs, the central controller can issue a trigger to the APs to initiate JTX. This can be useful in situations where the logical AP MLD architecture is implemented with a portion of the protocol stack running at the central controller.

According to one embodiment, an AP/AP MLD or a STA/non-AP MLD that supports JTX or any of the procedures for JTX described in this disclosure can advertise their support for the feature and/or the procedure in one or more frames that they transmit. If an AP/AP MLD supports JTX or any of the procedures for JTX then it can advertise its capabilities in one or more frames that it transmits. In one example, these frames can be management frames such as beacons, probe responses, (Re)association responses, etc. There can be a field (e.g., a bit) which can take a predetermined value (e.g., 1) to indicate the support and another predetermined value (e.g., 0) to indicate that the support is not present. If a STA/non-AP MLD supports JTX or any of the procedures for JTX then it can advertise its capabilities in one or more frames that it transmits. In one example, these frames can be management frames such as probe requests, (Re)association requests, etc. There can be a field (e.g., a bit) which can take a predetermined value (e.g., 1) to indicate the support and another predetermined value (e.g., 0) to indicate that the support is not present.

Those skilled in the art will appreciate that the above procedures can also be used for non-JTX related purposes wherever applicable and are not to be considered as limited to JTX. In addition, the above procedures can also be used in architectures such as the logical AP MLD architecture when applicable. Further, the information items indicated in this disclosure can be carried in any of the frames in the standard. Still further, the embodiments in this disclosure are not applicable to logical AP MLD alone and can be generally applicable to any setups involving joint transmission.

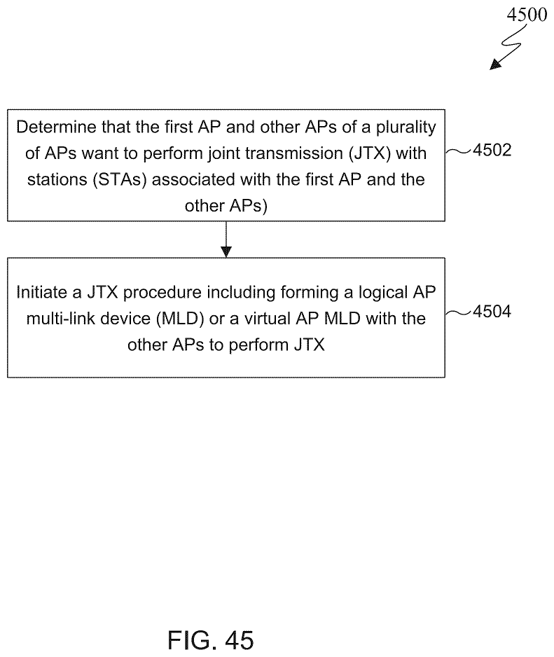

FIG. 45 illustrates a flow diagram of a method 4500 for wireless communication performed by a first AP device according to embodiments of the present disclosure. The example method 4500 shown in FIG. 45 is for illustration only. Other embodiments of the example method 4500 could be used without departing from the scope of this disclosure.

As illustrated in FIG. 45, the method 4500 begins at step 4502, where the first AP device determines that the first AP and other APs of a plurality of APs want to perform joint transmission (JTX) with stations (STAs) associated with the first AP and the other APs. At step 4504, the first AP device initiates a JTX procedure including forming a logical AP multi-link device (MLD) or a virtual AP MLD with the other APs to perform JTX.

In one embodiment, the AP device divides the logical AP MLD into (i) a shared component group configured to perform functionalities that are common to APs that form the logical AP MLD and (ii) a non-shared component group configured to perform functionalities that are specific to each AP that forms the logical AP MLD; or divides the virtual AP MLD into (i) a shared component group configured to perform functionalities that are common to APs that form the virtual AP MLD and (ii) a non-shared component group configured to perform functionalities that are specific to each AP that forms the virtual AP MLD.

In one embodiment, the AP device determines to initiate a channel sounding procedure for JTX; and transmits a trigger frame to the non-shared component group for initiating the channel sounding procedure.

In one embodiment, the AP device determines to collect channel sounding feedback from the STAs associated with the first AP and the other APs; transmits a second trigger frame to one or more of the other APs that will collect the channel sounding feedback; and receives information associated with the channel sounding feedback from the one or more of the other APs.

In one embodiment, the AP device transmits a message, to the other APs, associated with operation parameters of the other APs.

In one embodiment, the operation parameters of the first AP and the other APs are the same, the operation parameters comprising frequency resources including one or more of band, channel, and bandwidth.

In one embodiment, the AP device transmits a message, to the plurality of APs, associated with forming a group of APs from the plurality of APs to form the logical AP MLD or the virtual AP MLD and that can participate in JTX.

In one embodiment, the AP device receives a message from one or more APs of the plurality of APs requesting to join the group; and transmits a response to the one or more APs of the plurality of APs either approving or denying the request to join the group.

In one embodiment, the AP device shares data of the STAs associated with the first AP and the other APs with the other APs; and after sharing the data of the STAs, transmits a message to the other APs to start JTX.

In one embodiment, the AP device receives from an AP of the plurality of APs, a management frame indicating a capability of the AP of the plurality of APs to form a logical AP MLD or a virtual AP MLD for JTX.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first access point (AP), the method comprising:
determining that the first AP and other APs of a plurality of APs want to perform joint transmission (JTX) with stations (STAs) associated with the first AP and the other APs; and
initiating a JTX procedure including forming a logical AP multi-link device (MLD) or a virtual AP MLD with the other APs to perform JTX.

2. The method of claim 1, wherein initiating the JTX procedure comprises:
dividing the logical AP MLD into (i) a shared component group configured to perform functionalities that are common to APs that form the logical AP MLD and (ii) a non-shared component group configured to perform functionalities that are specific to each AP that forms the logical AP MLD; or
dividing the virtual AP MLD into (i) a shared component group configured to perform functionalities that are common to APs that form the virtual AP MLD and (ii) a non-shared component group configured to perform functionalities that are specific to each AP that forms the virtual AP MLD.

3. The method of claim 2, further comprising:
determining to initiate a channel sounding procedure for JTX; and
transmitting a trigger frame to the non-shared component group for initiating the channel sounding procedure.

4. The method of claim 3, further comprising:
determining to collect channel sounding feedback from the STAs associated with the first AP and the other APs;
transmitting a second trigger frame to one or more of the other APs that will collect the channel sounding feedback; and
receiving information associated with the channel sounding feedback from the one or more of the other APs.

5. The method of claim 1, wherein initiating the JTX procedure further comprises transmitting a message, to the other APs, associated with operation parameters of the other APs.

6. The method of claim 5, wherein the operation parameters of the first AP and the other APs are the same, the operation parameters comprising frequency resources including one or more of band, channel, and bandwidth.

7. The method of claim 1, further comprising transmitting a message, to the plurality of APs, associated with forming a group of APs from the plurality of APs to form the logical AP MLD or the virtual AP MLD and that can participate in JTX.

8. The method of claim 7, further comprising:
receiving a message from one or more APs of the plurality of APs requesting to join the group; and
transmitting a response to the one or more APs of the plurality of APs either approving or denying the request to join the group.

9. The method of claim 1, further comprising:
sharing data of the STAs associated with the first AP and the other APs with the other APs; and
after sharing the data of the STAs, transmitting a message to the other APs to start JTX.

10. The method of claim 1, further comprising receiving, from an AP of the plurality of APs, a management frame indicating a capability of the AP of the plurality of APs to form a logical AP MLD or a virtual AP MLD for JTX.

11. A first access point (AP) device comprising:
a transceiver configured to communicate over a link with a corresponding station (STA); and
a processor operably coupled to the transceiver, the processor configured to:
determine that the first AP and other APs of a plurality of APs want to perform joint transmission (JTX) with stations (STAs) associated with the first AP and the other APs; and
initiate a JTX procedure including forming a logical AP multi-link device (MLD) or a virtual AP MLD with the other APs to perform JTX.

12. The AP device of claim 11, wherein to initiate the JTX procedure, the processor is configured to:
divide the logical AP MLD into (i) a shared component group configured to perform functionalities that are common to APs that form the logical AP MLD and (ii) a non-shared component group configured to perform functionalities that are specific to each AP that forms the logical AP MLD; or
divide the virtual AP MLD into (i) a shared component group configured to perform functionalities that are common to APs that form the virtual AP MLD and (ii) a non-shared component group configured to perform functionalities that are specific to each AP that forms the virtual AP MLD.

13. The AP device of claim 12, wherein:
the processor is configured determine to initiate a channel sounding procedure for JTX; and
the transceiver is configured to transmit a trigger frame to the non-shared component group for initiating the channel sounding procedure.

14. The AP device of claim 13, wherein:
the processor is configured to determine to collect channel sounding feedback from the STAs associated with the first AP and the other APs;
the transceiver is configured to transmit a second trigger frame to one or more of the other APs that will collect the channel sounding feedback; and
the processor is further configured to receive information associated with the channel sounding feedback from the one or more of the other APs.

15. The AP device of claim 11, wherein to initiate the JTX procedure, the processor is configured, via the transceiver, to transmit a message, to the other APs, associated with operation parameters of the other APs.

16. The AP device of claim 15, wherein the operation parameters of the first AP and the other APs are the same, the operation parameters comprising frequency resources including one or more of band, channel, and bandwidth.

17. The AP device of claim 11, wherein the processor is configured, via the transceiver, to transmit a message, to the plurality of APs, associated with forming a group of APs from the plurality of APs to form the logical AP MLD or the virtual AP MLD and that can participate in JTX.

18. The AP device of claim 17, wherein:
the processor is configured to receive a message from one or more APs of the plurality of APs requesting to join the group; and
the transceiver is configured to transmit a response to the one or more APs of the plurality of APs either approving or denying the request to join the group.

19. The AP device of claim 11, wherein the processor is further configured, via the transceiver, to:
share data of the STAs associated with the first AP and the other APs with the other APs; and
after sharing the data of the STAs, transmit a message to the other APs to start JTX.

20. The AP device of claim 11, wherein the processor is configured to receive, via the transceiver, from an AP of the plurality of APs, a management frame indicating a capability of the AP of the plurality of APs to form a logical AP MLD or a virtual AP MLD for JTX.
